(19) United States
(12) Patent Application Publication
(10) Pub. No.: US 2026/0073685 A1
(43) Pub. Date: Mar. 12, 2026

(54) METHOD TO IDENTIFY AND AUGMENT AN INCOMPLETE TARGET OBJECT IMAGE TO FORM A COMPLETE COMPOSITE IMAGE OF THE TARGET OBJECT AT A WORKSITE AND AN APPARATUS FOR EXECUTING SAID METHOD

(71) Applicant: EarthCam Inc., Upper Saddle River, NJ (US)

(72) Inventors: Juan Navas, Fair Lawn, NJ (US); Brian CURY, Alpine, NJ (US)

(21) Appl. No.: 19/229,392

(22) Filed: Jun. 5, 2025

Related U.S. Application Data
(60) Provisional application No. 63/692,915, filed on Sep. 10, 2024.

(51) Int. Cl. G06V 20/20; G06T 5/50; G06T 7/00; G06T 11/00; G06V 10/776; G06V 10/98; G06V 20/70

(52) U.S. Cl. CPC G06V 20/20; G06T 5/50; G06T 7/0002; G06T 11/00; G06V 10/776; G06V 10/98; G06V 20/70; G06T 2207/30168

(57) ABSTRACT

A method for augmenting a target object orphan artifact image within a composite image. First, determining that only a target object orphan artifact image appears in the composite image and that a complete target object can be created. Second, reviewing a plurality of ground truth images and curated images of the target object and incorporating image elements therefrom into the target object orphan artifact image to create a target object child image. Third determining whether the target object child image is adequate based on a rubric score. If the rubric score indicates that the target object child image is adequate the method terminates. If the rubric score indicates that the target object child image is not adequate the method returns to the step of selecting another ground truth image or curated image of the target object.

### CROSS REFERENCE TO RELATED APPLICATION

The present application claims priority under 35 U.S.C. 119(e) to the provisional patent application filed on Sep. 10, 2024 and assigned application No. 63/692,915 (Attorney Docket Number 16569-007). The contents of that application are incorporated herein.

### BACKGROUND OF THE INVENTION

Each year, construction workers face numerous hazards on the job site each day. According to the Center for Construction Research and Training, since 2016, despite ongoing efforts to improve safety, more than 1,000 workers die on the job each year. More than one-third of the deaths result from falls to a lower level.

A 2022 study published by Occupational Safety and Health Administration (OSHA) identified the top ten most frequent causes for worker death and injury on worksites. Included in, but not limited to, the top ten causes for worker death and injury on worksites are: falls to a lower level, insufficient hazardous conditions communication, injury related the of ladders, poor protections from respiratory conditions, injury related to scaffolding, insufficient control of hazardous energy, injury from powered industrial vehicles, and injuries related to machinery and machine guarding.

The financial liability for general contractors working at worksites is enormous. General contractors are responsible for what they do on a worksite and for what their employees and subcontractors do. A lot can go wrong when working around electricity, water lines, power tools; heavy-duty vehicles; climbing ladders and scaffolding; working many stories above ground; working in every imaginable weather condition. Financial claims against contractors include early development structural issues; OSHA violations; water damage; damage to other people's property; bodily injury and death to others; and stolen equipment, tools, and supplies.

According to the 2023 Construction Disputes Report by Arcadis, the average value of construction disputes in North America was approximately $42.8 million, with the largest single claim at approximately $2 billion.

Identifying people, equipment and hazardous conditions is paramount to improving worksite safety and avoiding worker injuries and fatalities. It is also important for contractors defending against liability claims.

### BRIEF DESCRIPTION OF THE DRAWINGS

FIG. 1 illustrates a method to create a benchmark image

FIG. 2 illustrates a method to create criteria to select an image for upload to the input to the EC-F docu-vault

FIG. 3 illustrates a method to select an image for input to the EC-F docu-vault

FIG. 4 illustrates a method to identify an image to be uploaded to a not input to EC-F docu-vault

FIG. 5 illustrates a method to detect a target object waif artifact

FIG. 6 illustrates a method to acquire a ground truth image

FIG. 7 illustrates a method to compare a target object image with a ground truth image

FIG. 8 illustrates a method to determine if another epoch is required

FIG. 9 illustrates a method to create an accrete criteria

FIG. 10 illustrates a method to evaluate images and select an accrete criteria

FIG. 11 illustrates a method to evaluate images and select accrete criteria: target object.

FIG. 12 illustrates a method to create criteria for selecting accrete images for a target object waif artifact

FIG. 13 illustrates a method to select accrete images for a target object waif artifact

FIG. 14 illustrates a method to create criteria to resize an image

FIG. 15 illustrates a method to resize an image

FIG. 16 illustrates a method to create a resized child image

FIG. 17 illustrates a method to create criteria for evaluating noise in an image

FIG. 18 illustrates a method to change noise in an image

FIG. 19 illustrates a method to create a child image with the noise changed

FIG. 20 illustrates a method to create criteria for evaluating blur in an image

FIG. 21 illustrates a method to change blur in an image

FIG. 22 illustrates a method to create a child image with the blur changed

FIG. 23 illustrates a method to create criteria for evaluating contrast in an image

FIG. 24 illustrates a method to change contrast in an image

FIG. 25 illustrates a method to create a child image with the contrast changed

FIG. 26 illustrates a method to create criteria for evaluating saturation in an image

FIG. 27 illustrates a method to change saturation in an image

FIG. 28 illustrates a method to create a child image with the saturation changed

FIG. 29 illustrates a method to create criteria for transforming a target object waif artifact image into a complete target object image.

FIG. 30 illustrates a method to identify plenary image candidates for a target object waif artifact image

FIG. 31 illustrates a method to create criteria to identify a target object waif image within a complete image candidate

FIG. 32 illustrates a method to identify a target object waif artifact within a compete image

FIG. 33 illustrates a method to create a complete child image from a parent target object waif artifact image

### DETAILED DESCRIPTION OF THE INVENTION

Never before has it been possible to identify people, equipment, and hazardous conditions at a construction site in an evidentiary manner. Never before has it been possible to identify the entirety of an image of an object at a construction site in an evidentiary manner while preserving the image chain of custody. Never before has image data been related to real features and materials of an object on the ground in an evidentiary manner with an image chain of custody. The present invention teaches techniques that can be employed to overcome the deficiencies in the prior art.

A method to identify, acquire, create, and accrete a target object image, in its entirety, from a Target Object Waif Artifact Image (the waif artifact image also referred to herein as an orphan or orphan image) within an unqualified-unreserved image to thereby form a complete or whole image of the target object. In one embodiment, the unqualified-unreserved image is of a worksite. A Target Object Waif Artifact image is typically an image of a portion of the target object.

A complete (after accretion) target object image, and other related images, are used to create a Docu-Narrative, which comprises a plurality of images associated with a Client for whom the images are generated at a location (typically a location of interest to the client) during a specific period of time. A Client is typically an EarthCam (assignee of the present invention) customer, or a contractor of a Client or an agent of a Client.

A client location is an indoor or outdoor worksite, facility, or property.

The Docu-Narrative covers a period of time from a start date for capturing and including images to an end date when images are no longer captured. The images are created and maintained within the Docu-Narrative with multiple step operator certification and authentication processes, including an image chain of custody. The image chain of custody comprises an evidentiary-quality image creation, image maintenance, image accretion, image recording and image logging processes.

A method to identify, acquire, create, and accrete a target object image, in its entirety, from a Target Object Waif Artifact within an unqualified-unreserved image of an exemplary worksite uses a plurality of methods that are referred to by name and function in the Brief Description of the Drawings section above.

### Definitions

### Benchmark

As used herein, a benchmark is used with, but not limited to being used with, sensors, equipment, images, or objects for use in determining an object and its proximity to another object. A benchmark may be, but is not limited to being, a physical object, a digital object, a marking on a physical object, a geographic location, a quantitative measurement, a qualitative measurement, a condition, a color, a distance, a radio frequency, a data set, a calculation, a standard marker, or a state of being. A benchmark may be used, but is not limited to being used, as a basis for the evaluation, comparison, description, reference of the performance or output of a sensor or equipment, or direction and speed of an object used herein. An operator may establish how a benchmark is used.

### Client Project Folio

A Client Project Folio is an archival and current curated record and log of material information about a Worksite Alert System including, but is not limited to including, order entry system, sales order information, work order information. A method of logging material information for and about the above.

### Data Capture Equipment

Data Capture Equipment for accreting an object includes, but is not limited to including, cameras, sensors, alarms, lights, locks, motion sensors, measuring instruments, radiation sensors, weather equipment, air particle sensors, windspeed sensors, internet of things devices, remote devices, and other devices required for an Alert and are hereinafter called ‘Equipment’ or ‘Camera’.

### Docu-Narrative

A target object image and an image are used, but are not limited to being used, in a Docu-Narrative. A Docu-Narrative is a plurality of images associated with a Client Location but is not limited to a Client Location within a specific time range. A Client Location is an outdoor, but is not limited to outdoor, place, area, acreage, park, bridge, tunnel, or worksite, and not limited to a construction worksite, hereinafter called ‘worksite’. Images from the worksite are created and maintained with a multiple step operator certification and authentication process. The images are not used for facial recognition, gathering of personally identifiable information or enforcement against individuals. The certification and authentication process includes, but is not limited to including, an image chain of custody. The image chain of custody uses, but is not limited to using, an evidentiary quality image creation, image maintenance, image recording and image logging process. Images in a Docu-Narrative are not altered, concealed, falsified, or destroyed.

### Docu-Vault

A Docu-Vault is a secure datastore for images used in a Docu-Narrative. A Docu-Vault uses advanced data and physical security. The data security for the Docu-Vault includes, but is not limited to, data encryption, secured socket certificates, digital authentication, access rights management with multiple authentication layers and backup systems. The security for the physical server site includes, but is not limited to, alarmed access points, climate control, fire extinguisher and suppression, moisture detection, limited secure personnel access, no external windows, and a vault-like environment.

### Digital Object Bounding Box

A bounding box, volume or region, is a defining geometric shape, surrounding or enclosing a digital object, a group of objects or an image in a digital image hereinafter called an object. The bounding box defines the location and size of a digital object in a two-dimensional, three-dimensional, or four-dimensional image space.

A bounding box in a two-dimensional image may be represented by rectangles but not limited to rectangles. The sides of the rectangle run parallel to the x-axis and y-axis of a digital object. The minimum and maximum values of the x-axis and y-axis are specified by the pixel coordinates of the rectangle corners and determine the pixel size of the rectangle. The size and center point of the rectangle may be used to create an enclosing box about a digital object. A bounding box may also be represented by circle, cylinder, or sphere with a defined axis, radius, and vector. The axis, radius, and vector of the circle, cylinder or sphere may be used to create an enclosing circle, cylinder, or sphere about a digital object.

Three dimensional rectangular bounding boxes may be, but are not limited to being, represented by a parallelepiped, whose sides are parallel to the x-axis, y-axis, and z-axis of a digital object. The minimum and maximum values of the x-axis, y-axis and z-axis are specified by the pixel coordinates of the parallelepiped corners and determine the pixel size of the parallelepiped. The size and center point of the parallelepiped can be used to create an enclosing bonding box about a digital object.

A rectangular, circular, cylindrical, spherical, or parallelepiped bounding box are hereinafter called bounding box.

A bounding box may be used to identify and categorize objects. For example, a bounding box may be used to identify a digital object such as a person, car, wheelbarrow, dumpster, crane, frontend loader, or lightning from a larger image which would include other digital objects. A bounding box may be used to help crop, resize, rotate or accrete a digital object.

### Data Capture Equipment

Data Capture Equipment for an Alert includes, but is not limited to including, cameras, sensors, alarms, lights, locks, motion sensors, measuring instruments, radiation sensors, weather equipment, air particle sensors, windspeed sensors, internet of things devices, remote devices, and other devices required for an Alert and are hereinafter called ‘Equipment’.

### Digital Object Image Flag

A digital object image flag, hereinafter called ‘flag’ may be used to identify a target object image within, but not limited to, another image, an image in its entirety or larger image. An image other than a target image, an image in its entirety or image larger than a target image is hereinafter called a ‘Plenary Image’ but not limited to being called ‘image’ or ‘Plenary Image’.

A plenary image may contain many digital objects such as people, cars, wheelbarrows, dumpsters, cranes, frontend loaders, snow, or lightning. A flag may be used, but not limited to being used for digital objects which may appear in an external or internal plenary image of a worksite but not limited to a worksite.

A flag is used to quickly and accurately identify one digital object among many digital objects. A flag may have two parts, an alphanumeric identifier and a border. The alphanumeric identifier describes and identifies the digital object. It may appear at the top, but not limited to the top, of the flag. The border may be, but not limited to being, rectangular or circular and encloses the digital object. The alphanumeric identifier and the border may be the same color but not limited to the same color.

### Digital Object Veil

A digital object veil is used to identify a target object image within, but not limited to, a ‘Plenary Image’.

For example, a plenary image may contain many objects including, but not limited to, construction materials, glass, carpet, bricks, drywall, plywood, studs, and doors. A veil may be used, but not limited to being used for digital objects which may appear in an internal or external plenary image of a worksite but not limited to a worksite.

A veil has a color and is used to quickly and accurately identify one object among many objects by a specific color code. A unique color code may be used to identify a specific type, or class of construction material, but not limited to, a construction material. A colored veil covers the target object within the target object bounding box. A veil cover may have, but not limited in having, a 20 percent opacity. A veil may cover the target object with a unique color without obscuring the identity, shape, outline or form of the target object.

### Image Evidentiary Chain of Custody

An operator time stamps and updates the Client Project Folio with a two-level certification and authentication for an image chain of custody including, but is not limited to including, an image identification number, docu-vault storage identification, and a date and time for an evidentiary recording and logging process. All images, captured from a Client worksite location, are retained and preserved unchanged.

To maintain a reliable chain of custody, all images from a Client worksite location are always retained unchanged. Original images are also referred to as parent images in the Docu-Narrative. A child image is a duplicate of a parent image and is always associated with the parent image. A child image may be created to resolve image defects in the parent while the parent image is preserved unchanged. An entire child image or an image region may be accreted, modified in some way, or hidden from the view which the Client may see. An accreted child image is used to improve the clarity of the images in a Docu-Narrative and thereby promote worksite safety and regulatory compliance.

An operator continually certifies the image chain of custody and authenticates all parent and child images exist and no parent images have been destroyed, changed, augmented or missing.

### Operator

As used herein, an ‘operator’ can be, but not limited to being, any of the following or combination of any of the following: a person at a worksite, or a person remote from a worksite, or an EarthCam employee, or an EarthCam contractor, or an equipment resident computer or chipset, or a local computer, or a remote or distributed computer or chipset, or a digital instruction set.

### Remote Operator

As used herein, a ‘remote operator’ can be, but not limited to being, any of the following or combination of any of the following: a person at a worksite, or a person remote from a worksite, or an EarthCam employee, or an EarthCam contractor, or Surveyor, or an equipment resident computer or chipset, or a local computer, or a remote or distributed computer or chipset, or a digital instruction set, or a sensor, or data collection device.

### Worksite

A worksite may be a Client Location. It can be outdoors, but is not limited to an outdoor, place, area, acreage, park, bridge, tunnel, or worksite, and not limited to a construction worksite, hereinafter called ‘worksite’. A worksite includes, but not limited to including, structures above and below the ground, people, equipment, vehicles, materials, air space, and ground below the surface.

### Overview of the Invention

Sharp, clean, consistent images of a worksite are important for worker safety and worksite safety. Raindrops on a camera lens, fog at a worksite, overexposed images, and poor contrast images reduce the clarity of the images stored within the Docu-Narrative and thus the value of the chain of custody embodied in the Docu Narrative. Maintaining the Docu Narrative promotes worksite and worker safety; poor quality images detract from this objective. An image with one or more regions obscured, due to raindrops, for example, is of questionable value when the image is used to determine unsafe worksite conditions or to provide evidence of negligent actions.

To maintain a reliable chain of custody, original images (also referred to as parent images) in the Docu-Narrative always remain unchanged as new child images are created to resolve image defects in the parent. For example, entire images and image regions may be accreted, modified in some way, or hidden from a Client's view (that is, the images provided to the Client) to improve the clarity of the Docu-Narrative images and thereby promote safety. However, the original or parent image is preserved unchanged and never destroyed when a better child image is created from the parent image. The child image was accreted or modified as required and is included in the Client's view, while the parent image is hidden from the Client's view. The Docu-Narrative thus maintains the image chain of custody for all original and child images to preserve the evidentiary integrity of the Docu-Narrative, without cluttering the Client's view with substandard images.

As used herein, an ‘image’ is a photographic representation of an object or objects. As related to the present invention, the photographic representation is at a Client's worksite. A ‘Target Object Image’ is a photographic image of a target object within a larger image, intended to be the so called, “center of attention” within the image. A ‘Target Object Waif Artifact image’ is a photographic image of a part or component of a target object. A ‘Ground Truth Image’ is a high-quality photograph (i.e., with sufficient detail and without obstructions) of a Target Object or a Target Object Waif Artifact. Such “Ground Truth Images” may be taken at a Client's worksite. A ‘Curated Image’ is an EarthCam proprietary known-good image (e.g., high quality with no obstructions) of a target object or a target object waif artifact. These images are stored in a Curated Images Docu-Vault.

The methods of the present invention also set forth criteria and rubrics for identifying images within the Docu-Narrative that need accretion, the type of accretion required for each image, and for determining when the image content and quality is sufficient, that is, no additional accretion or modification is required, or the parent image is acceptable.

The Docu-Narrative may contain many thousands of original images captured by a camera, hereinafter called ‘unqualified-unreserved’ images as they have not been qualified for any process or reserved for any process. The inventive methods of the present invention reduce the processing time needed to produce sharp, clean, consistent images by creating smaller image subsets. The image subsets are then categorized by the type of accretion required to produce a quality image.

Of the many unqualified-unreserved images contained in the Docu-Narrative some images may require accretion, and some images may not require accretion. Images needing accretion are separated from images that do not need accretion, with the former images uploaded to a database referred to as an Accepted EC-F Docu-Vault.

In the present invention, an EarthCam image-formatting instruction set application, hereinafter called ‘EC-F’, uses a deep learning/machine learning environment to compare images.

The images stored in the Accepted EC-F Docu-Vault are input to an application referred to as EC-F, which is a software-based deep learning framework for building neural networks by combining the machine learning libraries with, but not limited to, a Python-based high-level application programming interface. EC-F allows an operator to build and run sophisticated deep learning networks while minimizing the time and labor spent on code and mathematical structures. It also allows an operator to run and test portions of code in real time, rather than waiting for the entire code to be implemented.

In the present invention, an ‘EC-F’ uses a deep learning/machine learning environment for comparing Target Objects or Target Object Waif Artifacts with Ground Truth Images and with Curated Images, to identify the best image match for the Target Object or for the Target Object Waif Artifact, i.e., an image that can be used to better identify and clarify Target Objects and Target Object Waif Objects. The best image match is then used to accrete the Target Object or the Target Object Waif Artifact to produce a Plenary Image, i.e., an image that is whole, complete, an entity in its entirety, and unobstructed, of the Target Object or the Target Object Waif Artifact image.

In a situation where the Target Object includes more than a single region, also called a bounding box or pixel location boundary, that needs accretion (according to its rubric score, for example) the comparison process is executed a number of times equal to the number of regions that require accretion because of a low rubric score.

Images needing a Target Object or a Target Object Waif Artifact to be hidden from the Client view, as explained above, are stored in a Hidden EC-F Docu-Vault but are never destroyed and always retained.

Target Objects and Target Object Waif Artifact images are compared to Ground Truth Images and Curated Images, using a bounding box comparison technique (and associated rubrics based on relevant criteria) to determine if the images are to be accreted or are to be hidden. The bounding box technique identifies and clarifies Target Objects and Target Object Waif Artifacts for hiding or for accretion. Hiding an image may be necessary, for example, if the rubric score indicates that it would not be possible to accrete the Target Object or the Target Object Waif Artifact to present a complete high-quality image.

Whenever a Target Object or a Target Object Waif Artifact image is accreted, the process generates a child image, which is associated with the parent image. The child image is then uploaded to the Detected Images Docu-Vault and referred to herein as a Plenary Image. Also, the parent image is hidden but not destroyed after the child image is created.

Methods of the present invention also create criteria and associated rubrics that might suggest other types of accretion or image modification are needed for Target Object Images and Target Object Waif Artifact images, that is, needed to generate a high-quality Plenary Image.

For example, images may need accretion or other modifications for any one or more of the following image characteristics:
Image size
Image noise content
Image contrast
Image blur
Image color saturation

If the rubrics score indicates that the respective image characteristic needs to be improved, the system processes the image (that is, the parent image) to improve the problematic image feature and thereby generates a child image. The child and parent images are then associated in the Docu Narrative to maintain the chain of custody relationship. The child image is uploaded to the Detected Images Docu Vault.

Each of the methods described herein includes steps that create and maintain a two-level certification and authentication for an image chain of custody including, but is not limited to, an image identification number for a parent and child image, a Docu-Vault storage location identification, a date and time when the child image was created (accreted or modify in some way) from the parent image. This recording of creation, image accretion, image maintenance, image recording, and image logging, etc. forms a complete and unbroken chain of custody for each image processed by the present invention.

### Method to Select an Image for Input to EC-F

EC-F is a software-based deep learning framework. It is used to build neural networks by combining the machine learning libraries with a Python-based high-level application programming interface. It is built on the Python programming language. EC-F allows an operator to build and run sophisticated deep learning networks while minimizing the time and labor spent on code and mathematical structure. It also allows an operator to run and test portions of code in real time, rather than wait for the entire code to be implemented.

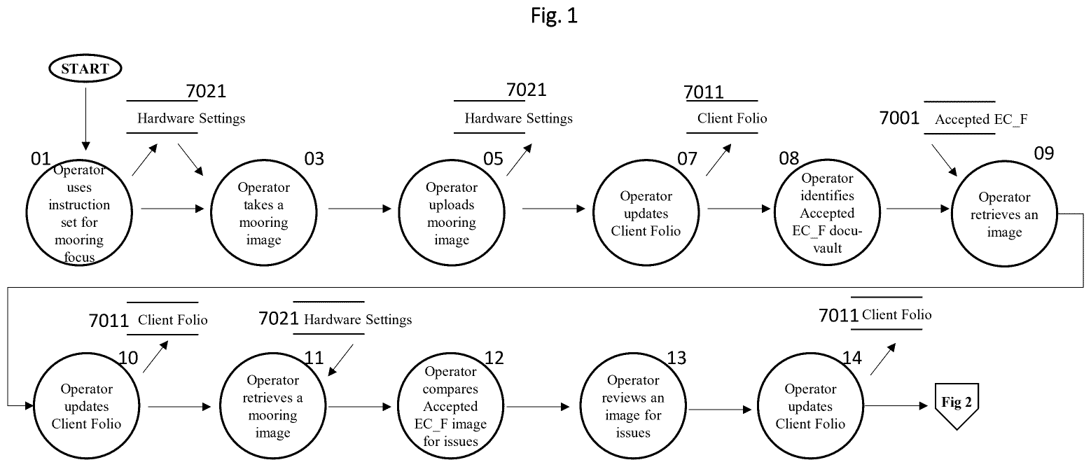

### FIG. 1 Method to Create a Benchmark Image

An operator uses an instruction set and procedure to produce a benchmark resolution and focus for an image.

An operator uses an instruction set to adjust the resolution and focus device so that benchmark images will be obtained by the camera used at the Client Location (01). Such a resolution and focus device is considered appropriate for the average body size of vehicles generally found at a worksite. The camera, with the resolution and focus adjusted to create benchmark images, is used to create a benchmark image at the Client Location. The resolution and focus device also provides metrics to judge the resolution of an image taken at the Client Location.

An operator takes a benchmark image (03). An operator stores a Benchmark Image in a Hardware Settings Docu-Vault (7021) (05). An operator uploads the camera specifications to the Hardware Settings Docu-Vault. An operator uploads the camera settings to the Hardware Settings Docu-Vault.

An operator updates and time stamps a Client Request with the resolution and focus settings that were used on the camera that created the benchmark image at the Client Location. An operator updates and time stamps the Client Request with the time that the operator stores the Benchmark Image in the Hardware Settings Docu-Vault (7021). (07)

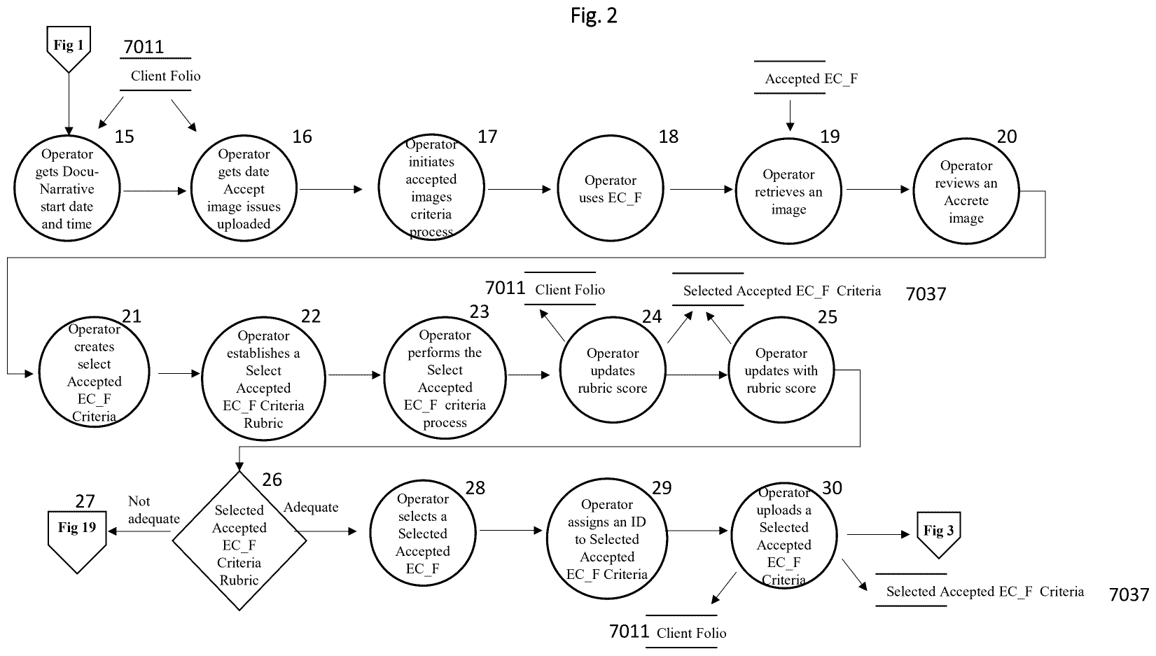

### FIG. 2 Method to Create Criteria to Select an Image for Upload to the Input to EC-F Docu-Vault

Unqualified-unreserved images stored in the Accepted EC-F Docu-Vault may have issues which require accretion. Criteria for identifying the possible image issues are needed to identify images which require accretion. A copy of the images which require accretion are stored in an Input To EC-F Docu-Vault.

Criteria are created for selecting Unqualified-unreserved images from an Accepted EC-F Docu-Vault and storing a copy of the Unqualified-unreserved image in an Input To EC-F Docu-Vault. The criteria are based on the issues found in the images selected from the Accepted EC-F Docu-Vault.

An operator identifies an Accepted EC-F Docu-Vault (7001) that includes a plurality of Unqualified-unreserved images associated with a Client Location. (08) These images are to be used for selecting an image to be input into EC-F.

An operator retrieves a Docu-Narrative start date and time and a Docu-Narrative end date and time from the Client Project Folio. An operator retrieves an image in the Accepted EC-F Docu-Vault, including a plurality of images in the Accepted EC-F Docu-Vault, which images are associated with the Client Location and have an image creation date between the Docu-Narrative start date and time and the Docu-Narrative end date and time (09).

An operator updates time stamps in the Client Project Folio with the time an operator retrieves an image from the Accepted EC-F Docu-Vault 7001. (10)

An operator retrieves a benchmark image from a Hardware Settings Docu-Vault (7021). (11)

An operator compares a benchmark image with an Accepted EC-F image to identify image issues. (12)

An operator checks for image issues concerning, a camera manufacturer camera model, camera orientation (rotation), camera firmware, date and time, YCbCr positioning, compression, X resolution, Y resolution, Resolution unit, Exposure time, F-number, exposure program, Exif version, date and time (original), date and time (digitized), components configuration, compressed bits per pixel, exposure bias, maximum aperture value, metering mode, flash, focal length, maker note, FlashPix version, color space, pixel X dimension, pixel Y dimension, file source, image file interoperability index, and image file interoperability version. (13).

An operator updates the Client Project Folio with issues identified in Accepted EC-F images. (14)

An operator retrieves the Docu-Narrative start date and time and the Docu-Narrative end date and time from the Client Project Folio. (15) An operator retrieves Client Project Folio with the date and time when a benchmark image was uploaded to the Hardware Settings Docu-Vault (7021) (16).

An operator initiates a process to create criteria for selecting images from, but not limited from including images from, Accepted EC-F Docu-Vault (7007) or from third party accrete image datastores (17). Images stored in an Accepted EC-F Docu-Vault are images taken from a Client worksite from a Docu-Narrative start date and time to a Docu-Narrative end date and time.

An operator uses EC-F to create criteria for selecting Accepted EC-F images (18).

An operator retrieves an Accepted EC-F image from the Accepted EC-F Docu-Vault (7019) associated with the Client Location with an image creation date between Docu-Narrative start date and time and the Docu-Narrative end date and time (19).

An operator reviews an Accepted EC-F image (20).

An operator creates a Select Accepted EC-F Image Criteria (21).

An operator establishes a Select Accepted EC-F Criteria Rubric (26), rules, and algorithm for determining if a Selected Accepted EC-F criteria is acceptable for selecting images to input into EC-F (22). The rubric may be metric, digital, subjective or any combination. The rubric, rules, and algorithm provide the operator with a method for grading the outcome of the determining if a Selected Accepted EC-F Criteria is acceptable and determining if the Selected Accepted EC-F Criteria Rubric score is acceptable.

An operator uses a value of 10 but not limited to 10, to indicate a score which is acceptable. An operator uses a value of 1 but not limited to 1, to indicate a score which is not adequate.

An operator performs the process of determining if the Selected Accepted EC-F Criteria is acceptable (23).

An operator updates the Client Project Folio (7011) with a grade for the outcome of determining if the Selected Accepted EC-F criteria is acceptable (24).

An operator updates the Selected Accepted EC-F Criteria Docu-Vault with a grade for the outcome of determining if the Selected Accepted EC-F criteria is acceptable (25).

An operator uses Selected Accepted EC-F Criteria Rubric (26).

If the Accrete Criteria Rubric score is not acceptable an operator retrieves another Accepted to EC-F image (19) and uses EC-F to create another criteria for selecting Selected Accepted EC-F Criteria (27.)

If the Selected Accepted EC-F Criteria Rubric score is acceptable, an Operator selects the criteria from the Selected Accepted EC-F Criteria (28).

An operator assigns a unique identification number to the Selected Accepted EC-F Criteria (29).

The unique Selected Accepted EC-F Criteria Identification Number incorporates a numeric chronological feature, and a multi-level and hierarchical sequence numbering feature.

An operator uploads the Selected Accepted EC-F Criteria to the Selected Accepted EC-F Criteria Docu-Vault (7037) with a unique Selected Accepted EC-F Criteria Identification Number. (30)

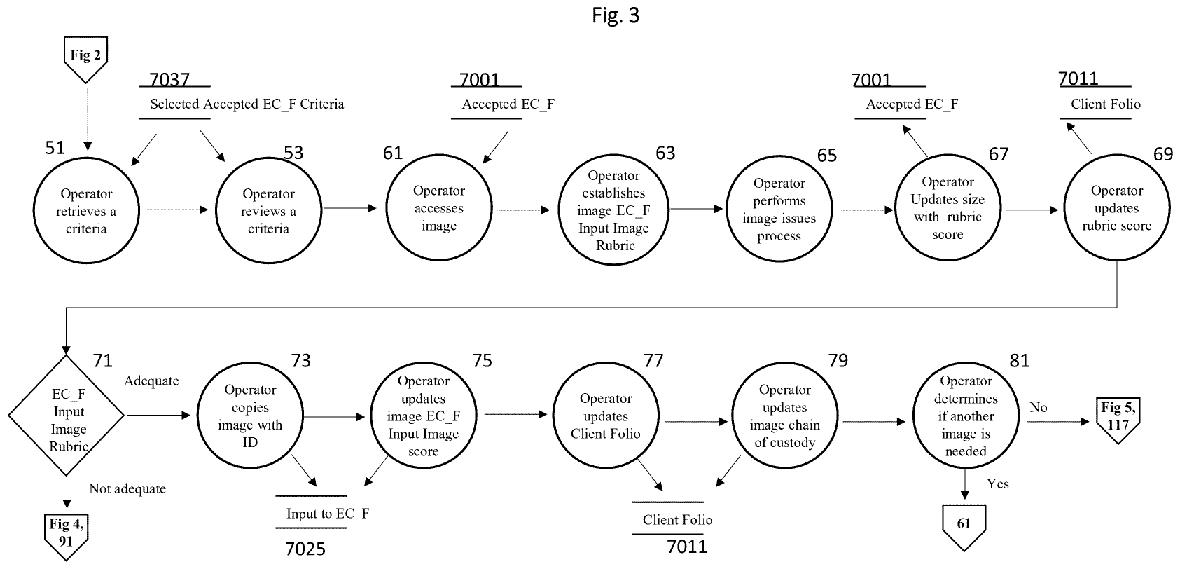

### FIG. 3 Method to Select an Image for Input to EC-F Docu-Vault

An operator retrieves criteria from a Selected Accepted EC-F Criteria Docu-Vault. (51) The criteria are used to identify images with issues which may require the image to be accreted. An image, from the Accepted EC-F Docu-Vault, with an image issue, is uploaded to the Input To EC-F Docu-Vault.

An operator reviews criteria from a Selected Accepted EC-F Criteria Docu-Vault. (53)

An operator accesses an image, for possible accretion, from an Accepted EC-F Docu-Vault using a Selected Accepted EC-F Criteria. (61) The images selected will be uploaded to an Input To EC-F Docu-Vault.

An operator establishes an EC-F Input Image Rubric (71), rules, and algorithm for determining if there are image issues in an image and if the image issues make the image acceptable or are not acceptable to be uploaded to an Input To EC-F Docu-Vault. (63). The rubric may be metric, digital, subjective or any combination thereof. The rubric, rules, and algorithm provide the operator with a method for grading the outcome for determining if the image issues make the image acceptable or are not acceptable to be uploaded to an Input To EC-F Docu-Vault are acceptable or not acceptable.

An operator uses a value of 10 to indicate a score which is acceptable. An operator uses a value of 1 to 1, to indicate a score which is not acceptable.

An operator executes the process for determining if the image issues make the image acceptable or are not acceptable to be uploaded to an Input To EC-F Docu-Vault (65).

An operator updates the image in the Accepted EC-F Docu-Vault with a grade for the outcome for determining if the image issues make the image acceptable or are not acceptable to be uploaded to an Input To EC-F Docu-Vault. is acceptable or not acceptable (67).

An operator updates the Client Project Folio (7011) with a grade for the outcome of for determining if the image issues make the image acceptable or are not acceptable to be uploaded to an Input To EC-F Docu-Vault is acceptable or not acceptable (69).

If an image has an acceptable rubric score, an operator copies the image to the Input To EC-F Docu-Vault (7025) and assigns the image a unique identification number (73). The unique Identification Number incorporates a numeric chronological feature, and a multi-level and hierarchical sequence numbering feature.

An operator updates the image in the Input To EC-F Docu-Vault (7025) with the EC-F Input Image Rubric score (75).

An operator time stamps the Client Request with the date and time that the acceptable images are copied to EC-F Docu-Vault (77).

An operator time stamps and updates the Client Project Folio (7011) with a two-level certification and authentication for an image chain of custody including an image identification number, Docu-Vault storage identification, and a date and time for an evidentiary quality image creation, image accretion, image maintenance, image recording and image logging process (79).

An operator determines if all images in an Accepted EC-F Docu-Vault have been reviewed for image issues or if another image needs to be reviewed for image issues (81).

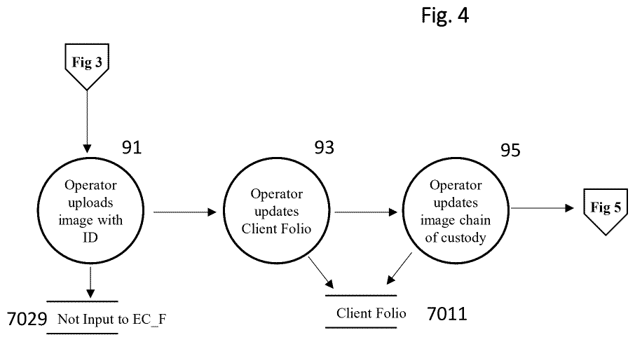

### FIG. 4 Method to Identify an Image to be Uploaded to a NOT Input to EC-F Docu-Vault

An operator uses criteria from a Selected Accepted EC-F Criteria Docu-Vault. (51) The criteria are used to identify images without issues and therefore do not need to be accreted. An image without an image issue is uploaded to a NOT Input To EC-F Docu-Vault.

If an image has an unacceptable EC-F Input Image Rubric score, an operator uploads the image to the NOT Input To EC-F Docu-Vault (7029) and assigns the image a unique identification number (91). The unique Identification Number incorporates a numeric chronological feature, and a multi-level and hierarchical sequence numbering feature. Images with an unacceptable EC-F Input Image Rubric score require no accretion.

An operator updates the image in the NOT Input To EC-F Docu-Vault (7029) with the EC-F Input Image Rubric score (93).

An operator time stamps the Client Request with the date and time the unacceptable images are copied to the NOT Input To EC-F Docu-Vault. An operator time stamps and updates the Client Project Folio (7011) with a two-level certification and authentication for the image chain of custody including, but is not limited to including, an image identification number, Docu-Vault storage identification, and a date and time for an evidentiary quality image creation, image accretion, image maintenance, image recording and image logging process (95).

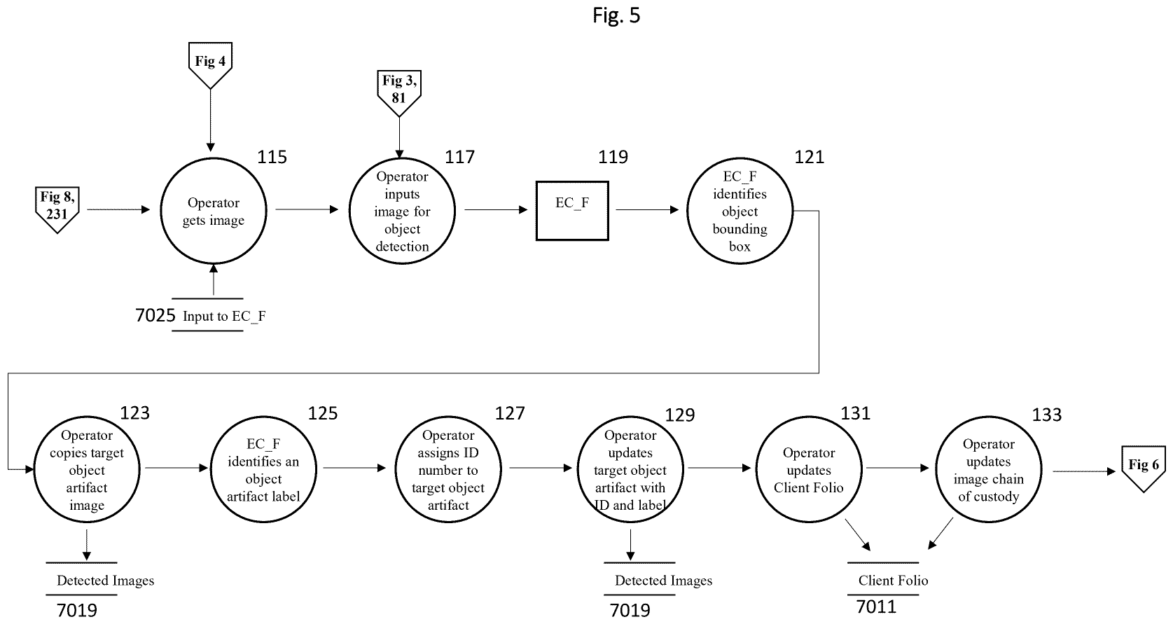

### FIG. 5 Method to Detect a Target Object Waif Artifact

Process to have EC-F perform Target Object Waif Artifact detection for an object within an unqualified-unreserved image. A target object within an unqualified-unreserved image is a complete form within an unqualified-unreserved image. A Target Object Waif Artifact within an unqualified-unreserved image is an incomplete form within an unqualified-unreserved image. An example of a target object within an unqualified-unreserved image is an unqualified-unreserved image of a raindrop on the camera lens which appears in the image. Another example is a dumpster on a worksite. An example of a Target Object Waif Artifact within an unqualified-unreserved image is the bucket portion of a frontend loader, with the remaining portion missing from the image. To provide a clearer view of a worksite, it is useful to create a child image without visible raindrops. Augment the child image to hide the raindrop images on the camera lens. Use the uncluttered child image in the Client's view of the worksite. Another example is to provide the Plenary image of a front-end loader when only the bucket portion (Target Object Waif Artifact) is clearly visible in the image of the worksite.

An operator retrieves an image from an Input To EC-F Docu-Vault (7025), associated with the Client Location with an image creation date between Docu-Narrative start date and time and the Docu-Narrative end date and time (115).

An operator inputs an image from the Input to EC-F Docu-Vault (7029) into EC-F for target object or Target Object Waif Artifact image detection (117).

EC-F identifies a Target Object Waif Artifact image bounding box between the starting and ending coordinates (121). A bounding box is an imaginary rectangle or other form that serves as a point of reference for object detection. It delineates the position and scale of an object within an unqualified-unreserved image or a video frame. A bounding box has a starting and ending coordinate. A bounding box is defined by several parameters that outline its position and size within an unqualified-unreserved image. These parameters include the coordinates of its location, as well as its width, height, and sometimes depth.

An operator copies the Target Object Waif Artifact image to the Detected Images Docu-Vault (7019) (123).

EC-F identifies a Target Object Waif Artifact label (125). A Target Object Waif Artifact label is an alphanumeric, but not limited to alphanumeric, text string which provides a description of the Target Object Waif Artifact.

An operator assigns a unique identification number to the target object image (127), The unique Identification Number incorporates, a numeric chronological feature, a multi-level and hierarchical sequence numbering feature and child identifier related with a parent image.

An operator updates the Target Object Waif Artifact image, in the Detected Images Docu-Vault (7019), with an identification number and a Target Object Waif Artifact label (127).

An operator updates the Target Object Waif Artifact image with an identification number and a Target Object Waif Artifact label (129). The unique Identification Number incorporates a numeric chronological feature, and a multi-level and hierarchical sequence numbering feature.

An operator time stamps and updates the Client Project Folio, with the date and time the acceptable images were input to EC-F for image detection. An operator time stamps and updates the Client Project Folio, with the date and time the acceptable images were copied to Detected Images Docu-Vault (7019) (131).

An operator time stamps and updates the Client Project Folio (7011) with a two-level certification and authentication for an image chain of custody including, an image identification number, Docu-Vault storage identification, and a date and time for an evidentiary quality image creation, image accretion, image maintenance, image recording and image logging process (133).

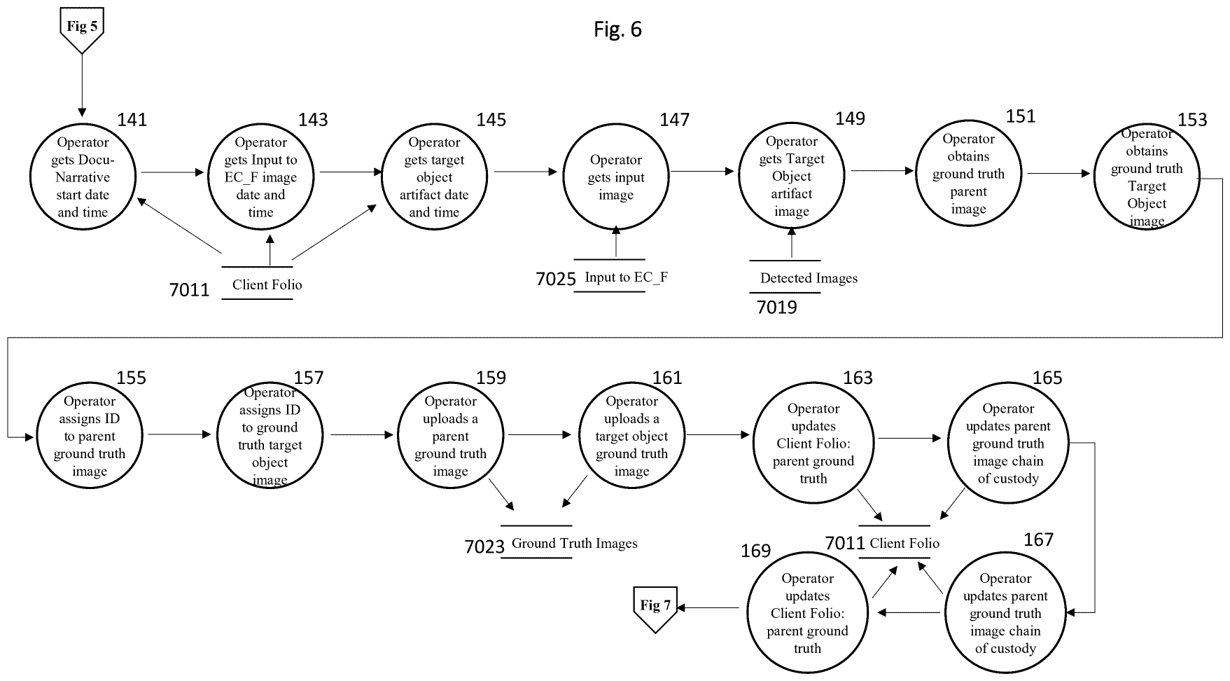

### FIG. 6 Method to Acquire a Ground Truth Image

A Ground Truth Image is a photograph or video of an object taken by an operator in the place where the object exists. An operator will travel to the object. Photograph the object, record the actual distance of the camera lens to the object and record the actual physical dimensions of the object.

An operator retrieves the Docu-Narrative start date and time and the Docu-Narrative end date and time from the Client Project Folio (141).

An operator retrieves Client Project Folio (7011) with the date and time that an acceptable image was uploaded to an Input To EC-F Docu-Vault (7029) (143).

An operator retrieves the Client Project Folio (7011) with the date and time that a Target Object Waif Artifact image was uploaded to a Detected Image Docu-Vault (145).

An operator retrieves an image from an Input To EC-F Docu-Vault (7025) (147).

An operator retrieves a Target Object Waif Artifact image from a Detected Images Docu-Vault (7019) (149). A Target Object Waif Artifact within an unqualified-unreserved image is an incomplete form within an unqualified-unreserved image. An example of a Target Object Waif Artifact within an unqualified-unreserved image is the bucket portion of a frontend loader, with the remaining portion missing from the image.

An operator visits the Client Location.

An operator obtains a Ground Truth Image of the parent acceptable image (151).

An operator obtains a Ground Truth Image of the Target Object Waif Artifact (153).

An operator assigns a unique identification number to a Ground Truth Image of the parent acceptable image (155). The unique Identification Number incorporates, a numeric chronological feature, a multi-level and hierarchical sequence numbering feature and child identifier related with a parent image.

An operator assigns a unique identification number to the Ground Truth Image of the target object image (157). The unique Identification Number incorporates a numeric chronological feature, a multi-level and hierarchical sequence numbering feature and child identifier related with a parent image.

An operator uploads a Ground Truth Image of a parent acceptable image to the Ground Truth Images Docu-Vault (7023) with a unique identification number. (159) The unique Identification Number incorporates a numeric chronological feature, a multi-level and hierarchical sequence numbering feature related with a parent image.

An operator uploads a Ground Truth Image of a target object image to the Ground Truth Images Docu-Vault (7023) with a unique identification number (161). The unique Identification Number incorporates a numeric chronological feature, a multi-level and hierarchical sequence numbering feature related with a parent image.

An operator time stamps and updates the Client Project Folio, with the date and time a Ground Truth Image of a parent acceptable Image was uploaded to the Ground Truth Images Docu-Vault (7023) (163).

An operator time stamps and updates the Client Project Folio (7011) with a two-level certification and authentication for a ground truth target object image chain of custody including, an image identification number, Docu-Vault storage identification, and a date and time for an evidentiary quality image creation, image accretion, image maintenance, image recording and image logging process (165).

An operator time stamps and updates the Client Project Folio (7011) with a two-level certification and authentication for a ground truth Target Object Waif Artifact image chain of custody including, an image identification number, Docu-Vault storage identification, and a date and time for an evidentiary quality image creation, image accretion, image maintenance, image recording and image logging process (167).

An operator time stamps and updates the Client Project Folio, with the date and time that a Ground Truth Image of a target object Image was uploaded to the Ground Truth Images Docu-Vault (7023) (169).

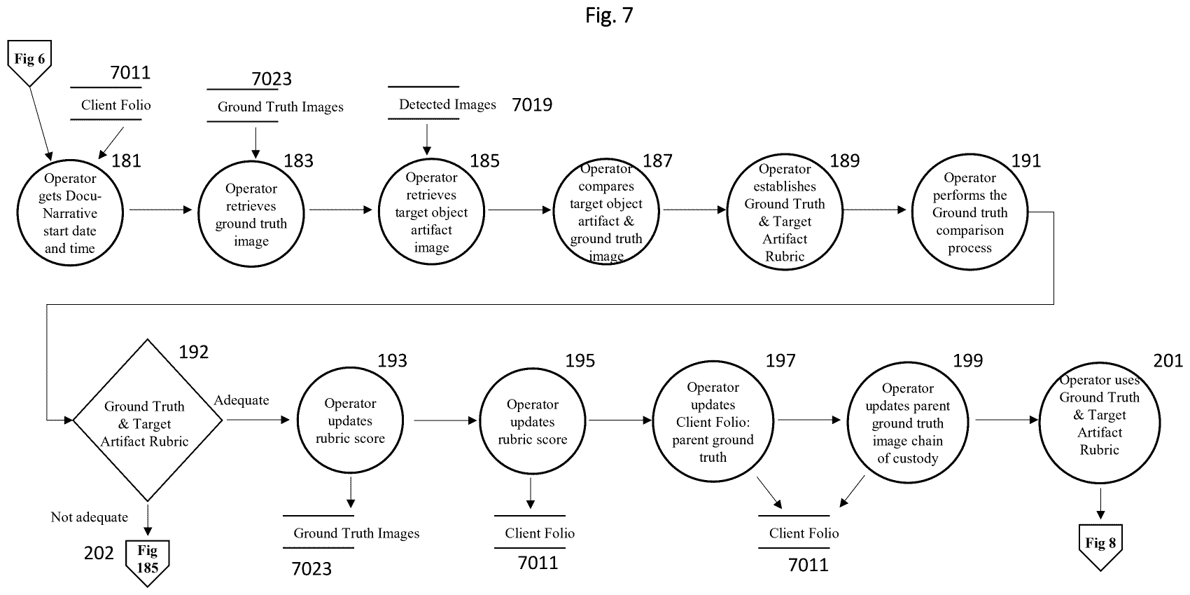

FIG. 7 Method to Compare Target Object with Ground Truth

Method to compare the detection of an image or Target Object Waif Artifact with a Ground Truth Image.

An operator retrieves the Client Project Folio (7011) with the date and time the Ground Truth Images were uploaded to the Ground Truth Images Docu-Vault (7023).

An operator retrieves the Docu-Narrative start date and time and the Docu-Narrative end date and time from the Client Project Folio (181).

An operator retrieves an image in the Ground Truth Images Docu-Vault (7023), associated with the Client Location (183).

An operator retrieves a Target Object Waif Artifact image from the Detected Images Docu-Vault (7019) located in the Detected Images Docu-Vault (7019), associated with the Client Location with an image creation date between Docu-Narrative start date and time and the Docu-Narrative end date and time (185).

An operator compares a Target Object Waif Artifact image with a Ground Truth Image (187).

An operator creates a Ground Truth & Target Artifact Rubric (192), rules, and algorithm for determining if a comparison of the Target Object Waif Artifact image to the Ground Truth Image is adequate (189).

The rubric may be metric, digital, subjective or any combination. The rubric, rules, and algorithm provide the operator with a method for grading the outcome of the comparison of the Target Object Waif Artifact image to the Ground Truth Image and determining whether the outcome is adequate/acceptable or not adequate/not acceptable and determining if the Ground Truth & Target Artifact Rubric score is acceptable.

In one embodiment, an operator uses a value of 10 to indicate a score which is acceptable. An operator uses a value of 1 to indicate a score which is not adequate.

An operator performs the process for determining if a comparison of the Target Object Waif Artifact image to the Ground Truth Image is adequate and is acceptable or not acceptable (191).

An operator updates the Ground Truth Images Docu-Vault (7023) with a grade for the outcome of the process of determining if a comparison of the Target Object Waif Artifact image to the Ground Truth Image is adequate/acceptable or not acceptable (193).

An operator updates the Client Project Folio (7011) with a grade for the outcome of determining if a comparison of the Target Object Waif Artifact image to the Ground Truth Image is adequate is acceptable or not acceptable (195).

An operator time stamps and updates the Client Project Folio, with the date and time the Ground Truth Images were compared to an image and to a Target Object Waif Artifact image (197).

An operator time stamps and updates the Client Project Folio (7011) with a two-level certification and authentication for an image chain of custody including, but is not limited to including, an image identification number, Docu-Vault storage identification, and a date and time for an evidentiary quality image creation, image accretion, image maintenance, image recording and image logging process (199).

An operator uses Ground Truth & Target Artifact Rubric for determining if a comparison of the Target Object Waif Artifact image to the Ground Truth Image is adequate (201).

If the Ground Truth & Target Artifact Rubric score is not adequate an operator returns to retrieve another Target Object Waif Artifact image from the Detected Images Docu-Vault (7019) located in the Detected Images Docu-Vault (7019), associated with the Client Location with an image creation date between Docu-Narrative start date and time and the Docu-Narrative end date and time at FIG. 185) (202).

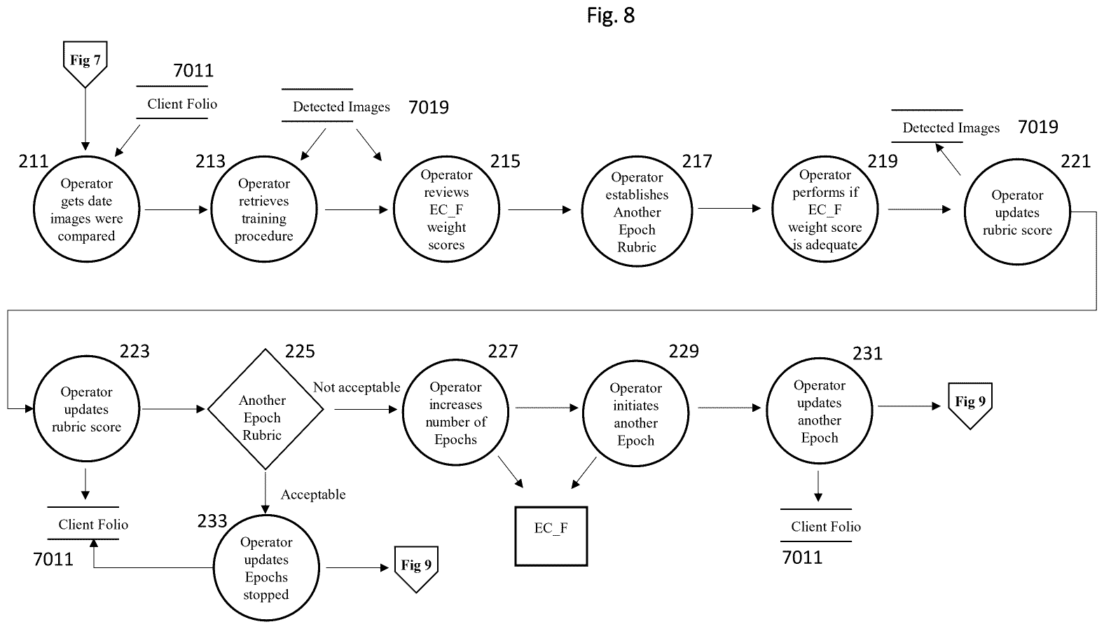

### FIG. 8 Method to Determine if Another Epoch Required

Method to determine if another Epoch is required in EC-F. An epoch is an iteration of the EC-F process.

An operator retrieves the Client Project Folio with the date and time the Ground Truth Images were compared to an image or to a Target Object image or to a Target Object Waif Artifact image (211). The comparison of a Ground Truth image to an image or Target Object image or Target Object Waif Artifact image provides the basis for an accurate accretion.

An operator retrieves the appropriate EC-F training procedure which was applied to the image from the Detected Image Docu-Vault. The training procedure includes the variables and values that determine the optimization and accuracy of the EC-F process. The greater the optimization and accuracy of the process the better the image outcomes and efficiency of the process (213).

An operator retrieves the weight and average precision scores from the Detected Image Docu-Vault and reviews an image or a Target Object Image or a Target Object Waif Artifact image and the weight and average precision scores produced by EC-F for the current Epoch. (215). The weight and average precision scores provide a reference for an operator to, but not limited to resizing with the right resolution and interpolation, applying inference transforms, and rescaling the values.

An operator establishes an Another Epoch Rubric (225), rules, and algorithm for determining if an image, or Target Object image or a Target Object Waif Artifact image has an acceptable EC-F weight and average precision score to be input to EC-F (217).

The rubric may be metric, digital, subjective or any combination. The rubric, rules, and algorithm provide the operator with a method for grading the outcome of the determining if an image, or Target Object image or a Target Object Waif Artifact image has an acceptable EC-F weight and average precision score to be input to EC-F which is acceptable or not acceptable and determining if the Another Epoch Rubric score is acceptable.

An operator uses a value of 10 but not limited to 10, to indicate a score which is acceptable. An operator uses a value of 1 but not limited to 1, to indicate a score which is not adequate.

An operator performs the process for determining if an image, or Target Object image or a Target Object Waif Artifact image has an acceptable EC-F weight and average precision score to be input to EC-F is acceptable or not acceptable (219).

An operator updates the Client Project Folio with a grade for the outcome for determining if an image, or Target Object image or a Target Object Waif Artifact image has an acceptable EC-F weight and average precision score to be input to EC-F is acceptable or not acceptable (223).

An operator updates the Another Epoch Rubric score in the Detected Images Docu-Vault with a grade for the outcome of determining if an image, or Target Object image or a Target Object Waif Artifact image has an acceptable EC-F weight and average precision score to be input to EC-F is acceptable or not acceptable (221).

An operator uses Another Epoch Rubric (225).

If the Another Epoch Rubric score is not adequate an operator increases the number of Epochs (227).

If the Another Epoch Rubric score is not adequate an operator initiates another Epoch (229).

An operator updates the Client Project Folio with date, time and the current Epoch number (231).

If the weight and average precision scores are acceptable an operator time stamps and updates the Client Project Folio, with the date and time the EC-F Epoch was stopped (233).

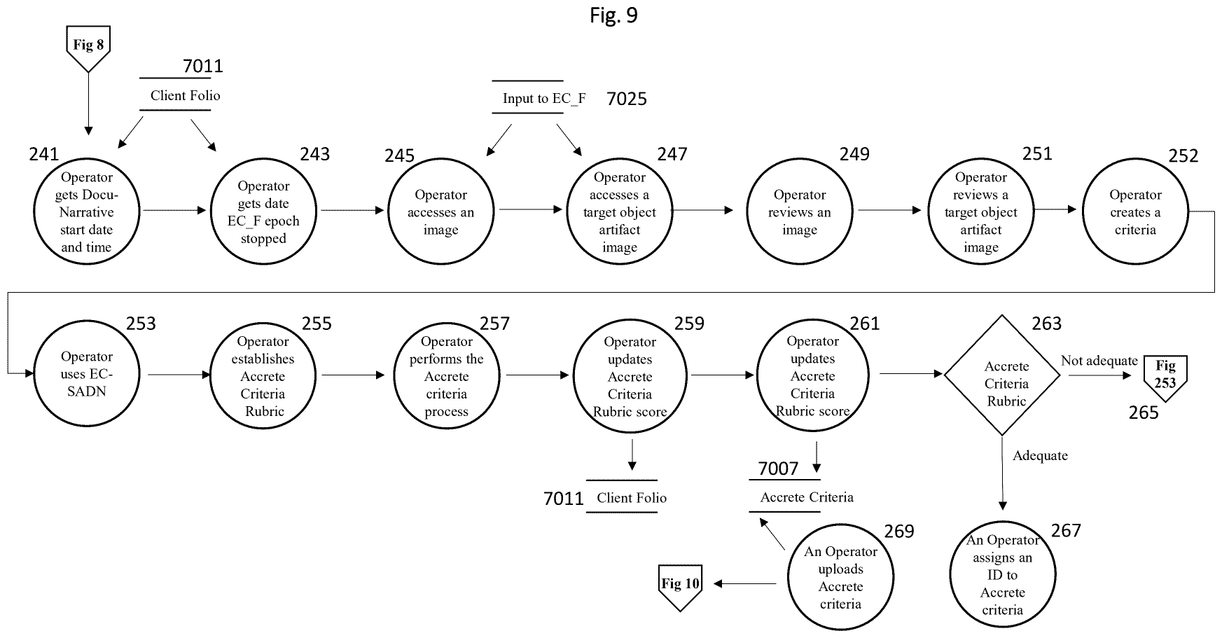

### FIG. 9 Method to Create Accrete Criteria

Method to create criteria for accreting images.

An operator retrieves the Docu-Narrative start date and time and the Docu-Narrative end date and time from the Client Project Folio (241).

An operator retrieves the Client Project Folio with the date and time when the weight and average precision score was considered adequate and the EC-F Epoch was stopped (243).

An operator accesses an image from an Input To EC-F Docu-Vault (7025) (245).

An operator accesses a Target Object Waif Artifact image from an Input To EC-F Docu-Vault (7025) (247).

An operator reviews an image from an Input To EC-F Docu-Vault (249).

An operator reviews a Target Object Waif Artifact image from an Input To EC-F Docu-Vault (251).

An operator creates Accrete Criteria (252).

An operator uses an EarthCam Software Algorithm for MAYBE “FROM” INSTEAD OF “FOR” a Docu-Narrative Instruction Set and procedure to create criteria for accreting a Target Object Waif Artifact image into an image of the entire target object (253).

An operator establishes an Accrete Criteria Rubric (263), rules, and algorithm for determining if Accrete Criteria for a Target Object Waif Artifact is acceptable (255).

The rubric may be metric, digital, subjective or any combination. The rubric, rules, and algorithms provide the operator with a method for grading the outcome of the determining if Accrete Criteria for a Target Object Waif Artifact is acceptable and determining if the Accrete Criteria Rubric score is acceptable.

An operator uses a value of 10 to indicate a score which is acceptable. An operator uses a value of 1 to indicate a score which is not adequate.

An operator performs the process to determine if Accrete Criteria for a Target Object Waif Artifact is acceptable (257).

An operator updates the Client Project Folio (7011) with a grade for the outcome of determining if Accrete Criteria for a Target Object Waif Artifact is acceptable (259).

An operator updates the Argument Criteria Docu-Vault with the grade from step (259) (261).

An operator uses Accrete Criteria Rubric to determine if Accrete Criteria for a Target Object Waif Artifact has an acceptable rubric score for the Target Object Waif Image to be accreted (263).

If the Accrete Criteria Rubric score is not acceptable an operator uses an EarthCam Software Algorithms, a Docu-Narrative Instruction Set and procedure to create another criteria for accreting a Target Object Waif Artifact image into an entire image of the object (265).

If the Accrete Criteria Rubric score is acceptable the operator assigns a unique identification number to an Accrete Criteria (267). The unique Accrete Criteria Identification Number incorporates a numeric chronological feature, and a multi-level and hierarchical sequence numbering feature.

An operator uploads an Accrete Criteria to the Accrete Criteria Docu-Vault (7007) with a unique Accrete Criteria Identification Number (269).

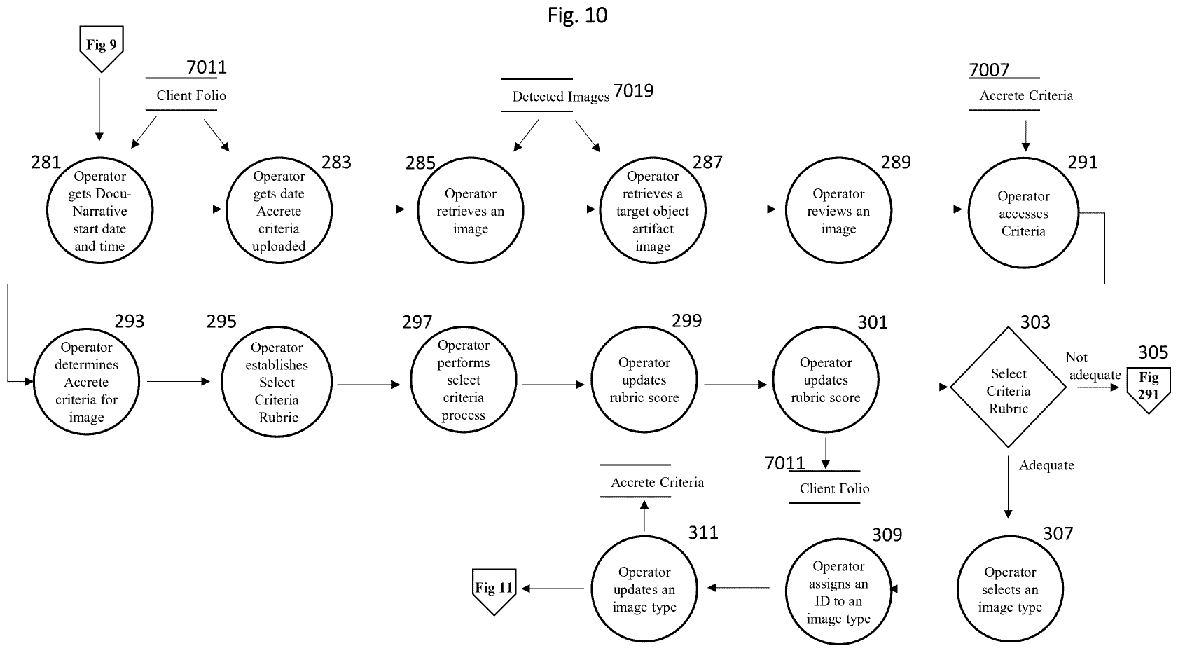

### FIG. 10 Method to Evaluate Images and Select Accrete Criteria

Method to evaluate images for accreting.

An operator retrieves the Docu-Narrative start date and time and the Docu-Narrative end date and time from the Client Project Folio (281).

An operator retrieves Client Project Folio (FIG. 5) with the date and time when Accrete Criteria and an Accrete Criteria rubric score were uploaded to the Accrete Image Candidates Docu-Vault (7007) (283).

An operator retrieves an image from the Detected Images Docu-Vault (7019), associated with the Client Location with an image creation date between Docu-Narrative start date and time and the Docu-Narrative end date and time (285).

An operator retrieves a Target Object Waif Artifact image in the Detected Images Docu-Vault (7019) associated with the Client Location with an image creation date between Docu-Narrative start date and time and the Docu-Narrative end date and time (287).

An operator reviews an image (289).

An operator accesses criteria from an Accrete Criteria Docu-Vault (7007) (291).

An operator determines the appropriate Accrete Criteria to apply to the image (293).

An operator establishes a Select Criteria Rubric (303), rules, and algorithm for determining if Accrete Criteria is appropriate for an image (295).

The rubric may be metric, digital, subjective or any combination. The rubric, rules, and algorithms provide the operator with a method for grading the outcome of the determining if Accrete Criteria is appropriate for an image is acceptable or not acceptable process and determining if the Select Criteria Rubric score is acceptable.

An operator uses a value of 10 but not limited to 10, to indicate a score which is acceptable. An operator uses a value of 1 but not limited to 1, to indicate a score which is not adequate.

An operator performs the process for determining if Accrete Criteria is appropriate for an image is acceptable or not acceptable. (297).

An operator updates Select Criteria Rubric score in Accrete Criteria Docu-Vault (7007) with a grade for the outcome of the determining if Accrete Criteria is appropriate for an image is acceptable or not acceptable (299).

An operator updates the Client Project Folio (7011) with a grade for the outcome for determining if Accrete Criteria is appropriate for an image (301).

An operator uses Select Criteria Rubric. (303)

If the Select Criteria Rubric score is not adequate an operator selects another criteria (305).

An operator reviews the mAP and associated statistics related to an image. The operator determines which accrete image type, but not limited to an accrete image type, to use based on, but not limited to, the Select Criteria Rubric, and the operator's analysis and judgement of the mAP and associated statistics (307).

An operator assigns a unique identification number to an accrete image type (309).

The unique Identification Number incorporates a numeric chronological feature, and a multi-level and hierarchical sequence numbering feature.

An operator updates the Accrete Criteria Docu-Vault (7007) with an accrete image type (311).

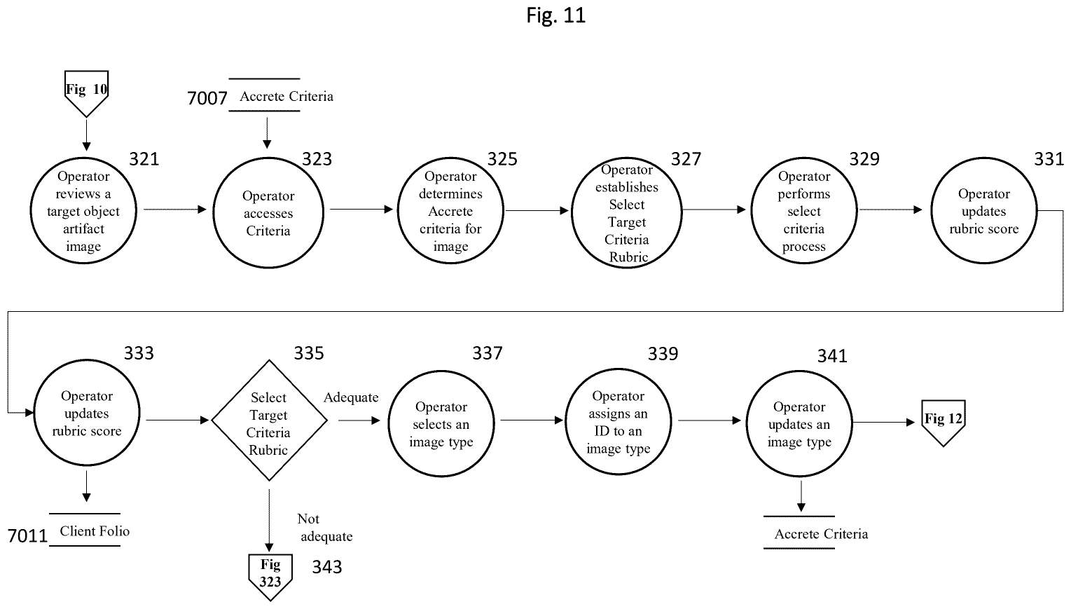

### FIG. 11 Method to Evaluate Images and Select Accrete Criteria: Target Object.

An operator reviews a Target Object Waif Artifact image (321).

An operator accesses an Accrete Criteria from an Accrete Criteria Docu-Vault (7007) (323).

An operator determines the appropriate Accrete Criteria to apply to the image. (325)

An operator establishes a Select Target Criteria Rubric (335), rules, and algorithm for determining if Accrete Criteria is appropriate for a Target Object Waif Artifact image (327).

The rubric may be metric, digital, subjective or any combination. The rubric, rules, and algorithms provide the operator with a method for grading the outcome of the determining if an Accrete Criteria is appropriate for a Target Object Waif Artifact image is acceptable or not acceptable process and determining if the Select Criteria Rubric score is acceptable.

An operator uses a value of 10 but not limited to 10, to indicate a score which is acceptable. An operator uses a value of 1 but not limited to 1, to indicate a score which is not adequate.

An operator performs the process for determining if an Accrete Criteria is appropriate for a Target Object Waif Artifact image is acceptable or not acceptable (329).

An operator updates Select Target Criteria Rubric score in Accrete Criteria Docu-Vault (7007) with a grade for the outcome of the determining if an Accrete Criteria is appropriate for a Target Object Waif Artifact image is acceptable or not acceptable (331).

An operator updates the Client Project Folio (7011) with a grade for the outcome of determining if an Accrete Criteria is appropriate for a Target Object Waif Artifact image (333).

An operator uses Select Criteria Rubric. (335).

If the Select Target Criteria Rubric score is not adequate an operator selects another criteria (343).

An operator reviews the mAP and associated statistics related to an image. The operator determines which accrete images, but not limited to accrete images, to use based on, but not limited to, the Select Criteria Rubric, and the operator's analysis and judgement of the mAP and associated statistics (337).

An operator assigns a unique identification number to an accrete image type (339).

The unique Identification Number incorporates a numeric chronological feature, and a multi-level and hierarchical sequence numbering feature.

An operator updates the Accrete Criteria Docu-Vault (7007) with an accrete image type (341).

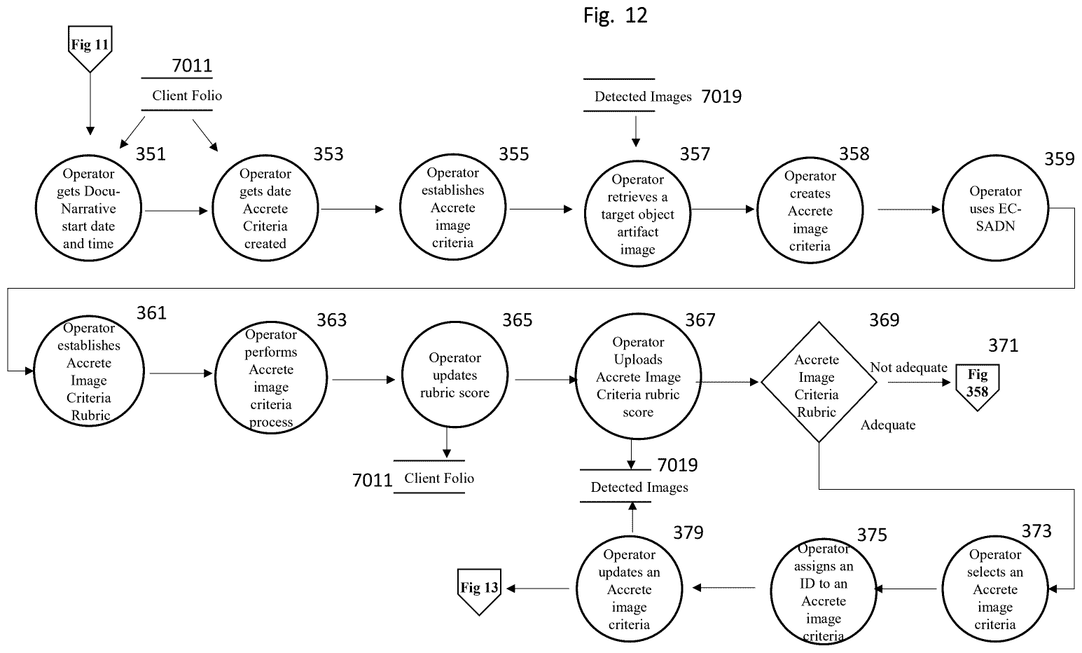

### FIG. 12 Method to Create Criteria for Selecting Accrete Images for a Target Object Waif Artifact

An operator retrieves the Docu-Narrative start date and time and the Docu-Narrative end date and time from the Client Project Folio (351).

An operator retrieves Client Project Folio with the date and time when the Accrete Image Criteria and Rubric were uploaded to the Accrete Criteria Docu-Vault (7007) (353).

An operator initiates a process to create criteria for selecting accrete images from, but not limited from including images from, EarthCam proprietary Curated Images Docu-Vault (7017) or from third party accrete image datastores (355).

An operator retrieves a Target Object Waif Artifact image in the Detected Images Docu-Vault (7019) associated with the Client Location with an image creation date between Docu-Narrative start date and time and the Docu-Narrative end date and time (357).

An operator reviews a Target Object Waif Artifact image.

An operator creates an Accrete Image Criteria (358).

An operator uses an EC-SADNEC-SADN Instruction Set and procedure to create criteria for accreting a Target Object Waif Artifact image into an image of its entirety (359).

An operator establishes an Accrete Image Criteria Rubric (369), rules, and algorithm for determining if accrete image criteria for a Target Object Waif Artifact is acceptable (361).

The rubric may be metric, digital, subjective or any combination. The rubric, rules, and algorithm provide the operator with a method for grading the outcome of the determining if an accrete image for a Target Object Waif Artifact is acceptable and determining if the Accrete Image Criteria Rubric score is acceptable.

An operator uses a value of 10 but not limited to 10, to indicate a score which is acceptable. An operator uses a value of 1 but not limited to 1, to indicate a score which is not adequate.

An operator performs the process to determine if an accrete image for a Target Object Waif Artifact is acceptable (363).

An operator updates the Client Project Folio (7011) with a grade for the outcome of determining if an accrete image for a Target Object Waif Artifact is acceptable (365).

An operator updates the Detected Image Docu-Vault with a grade for the outcome of determining if an accrete image criteria for a Target Object Waif Artifact is acceptable (367).

An operator uses Accrete Image Criteria Rubric (369).

If the Accrete Criteria Rubric score is not acceptable an operator uses an EC-SADNEC-SADN Instruction Set and procedure to create another criteria for accreting a Target Object Waif Artifact image into an image of its entirety (371).

If the Accrete Criteria Rubric score is acceptable and Operator selects the criteria for selecting an accrete image for a Target Object Waif Artifact (373).

An operator assigns a unique identification number to an accrete image criteria (375).

The unique Accrete Image Criteria Identification Number incorporates a numeric chronological feature, and a multi-level and hierarchical sequence numbering feature.

An operator uploads accrete image criteria to the Accrete Criteria Docu-Vault (7007) with a unique Accrete Criteria Identification Number (379).

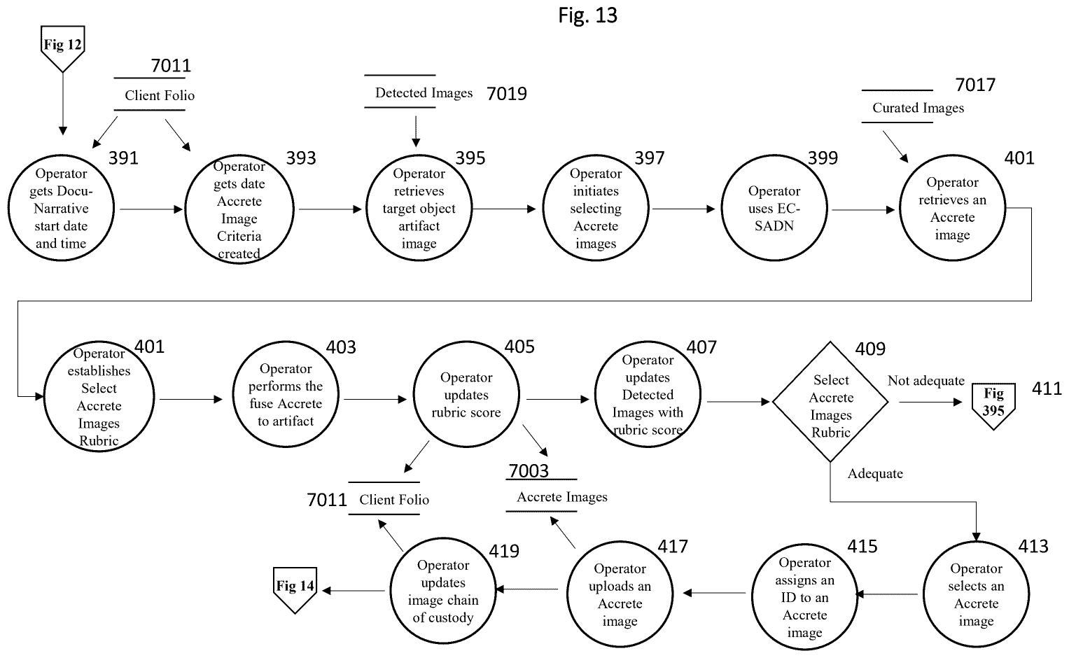

### FIG. 13 Method to Select Accrete Images for a Target Object Waif Artifact

An operator retrieves the Docu-Narrative start date and time and the Docu-Narrative end date and time from the Client Project Folio (391).

An operator retrieves Client Project Folio with the date and time when the Accrete Image Criteria and Rubric were uploaded to the Accrete Criteria Docu-Vault (7007) (393).

An operator retrieves a Target Object Waif Artifact image in the Detected Images Docu-Vault (7019) associated with the Client Location with an image creation date between Docu-Narrative start date and time and the Docu-Narrative end date and time (395).

An operator initiates a process to select accrete images from, but not limited from including images from, EarthCam proprietary Curated Images Docu-Vault (7017) or from third party accrete datastores (397).

An operator uses an EC-SADNEC-SADN Instruction Set and procedure to select accrete images to accrete a Target Object Waif Artifact image into an image of its entirety (399).

An operator selects an accrete image from, but not limited from including an image from, EarthCam proprietary Curated Images Docu-Vault (7017) or from third party accrete datastores (401).

EarthCam Curated Images Docu-Vault (7017) include but are not limited to including images of blurred accrete images, light exposure accrete images, raindrop accrete images, dirt on a lens accrete images, mud on a lens accrete images, and environment accrete images including, but not limited to including, accrete images of people, accrete images of ladders, accrete images of scaffolding, accrete images of vehicle, accrete images of heavy equipment, and accrete images of construction equipment.

An operator establishes a Select Accrete Images Rubric (409), rules, and algorithm for determining if an accrete image, when fused with a Target Object Waif Artifact transforms a Target Object Waif Artifact into an image of the target object in its entirety (401).

The rubric may be metric, digital, subjective or any combination. The rubric, rules, and algorithm provide the operator with a method for grading the outcome of the determining if an accrete image, when merged with a Target Object Waif Artifact transforms a Target Object Waif Artifact into an image of the target object in its entirety is acceptable or not acceptable process and determining if the Select Accrete Images Rubric score is acceptable.

An operator uses a value of 10 but not limited to 10, to indicate a score which is acceptable. An operator uses a value of 1 but not limited to 1, to indicate a score which is not adequate.

An operator performs the process for determining if an accrete image, when merged with a Target Object Waif Artifact transforms a Target Object Waif Artifact into an image of the target object in its entirety is acceptable or not acceptable (403).

An operator updates Select Accrete Images Rubric score in Accrete Images Docu-Vault with a grade for the outcome for determining if an accrete image, when merged with a Target Object Waif Artifact transforms a Target Object Waif Artifact into an image of the target object in its entirety is acceptable or not acceptable (405).

An operator updates the Client Project Folio (7011) with a grade for the outcome of the determining if an accrete image, when merged with a Target Object Waif Artifact transforms a Target Object Waif Artifact into an image of the target object in its entirety (407).

An operator uses Select Accrete Images Rubric (409).

If the Select Accrete Images Rubric score is adequate an operator selects an accrete image (413).

An operator assigns a unique identification number to a selected accrete image (415).

The unique Identification Number incorporates a numeric chronological feature, and a multi-level and hierarchical sequence numbering feature. The unique identification number associates the accrete image with the Target Object Waif Artifact image.

An operator uploads an Accrete Image to an Accrete Images Docu-Vault (7003) (417).

An operator time stamps and updates the Client Project Folio (7011) with a two-level certification and authentication for an image chain of custody including, but is not limited to including, an image identification number, Docu-Vault storage identification, and a date and time for an evidentiary quality image creation, image accretion, image maintenance, image recording and image logging process (419).

If the Select Accrete Images Rubric score is not adequate an operator selects another accrete image (411).

A process to Resize. A process to determine how much to change the size of an image. Changing the size includes, but is not limited to including, changing the size of width, height, and resolution of an image without changing the number of pixels an image; and changing by increasing or decreasing the number of pixels in an image.

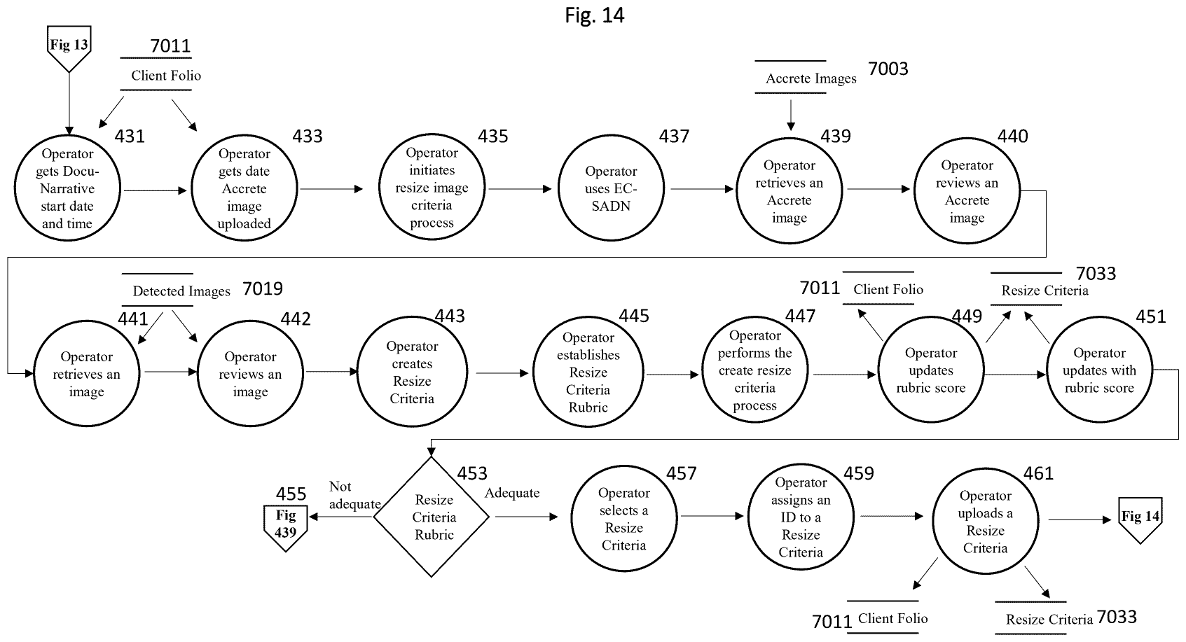

### FIG. 14 Method to Create Criteria to Resize an Image

An operator retrieves the Docu-Narrative start date and time and the Docu-Narrative end date and time from the Client Project Folio (431).

An operator retrieves Client Project Folio with the date and time when an operator uploads an Accrete Image to an Accrete Images Docu-Vault (7003) (433).

An operator initiates a process to create criteria for selecting Accrete Images from, but not limited from including images from, a plurality of EarthCam proprietary Curated Images Docu-Vaults (7017) 7003 and from third party Accrete Image datastores (435).

An operator uses an EarthCam proprietary EarthCam-Software Algorithms for a Docu-Narrative instruction set to determine the criteria for resizing an image. The image resizing criteria include, but are not limited to, the number of pixels high, pixels wide and the number of color channels (437).

An operator retrieves an Accrete Image from an Accrete Images Docu-Vault (7003) (439).

An operator reviews an Accrete Image from an Accrete Images Docu-Vault (7003) (440).

An operator retrieves an image or Target Object Waif Artifact image from a Detected Images Docu-Vault (7019) (441).

An operator reviews an image or Target Object Waif Artifact Accrete Image from a Detected Images Docu-Vault (7019) (442).

An operator creates a Resize Criteria (443).

An operator establishes a Resize Criteria Rubric (453), rules, and algorithm for creating criteria for resizing an image which produces an acceptable image (445).

The rubric may be metric, digital, subjective or any combination. The rubric, rules, and algorithm provide the operator with a method for grading the outcome to determine if criteria to resize an image is acceptable or not acceptable and determine if the Resize Criteria Rubric score is acceptable.

An operator uses a value of 10 but not limited to 10, to indicate a score which is acceptable. An operator uses a value of 1 but not limited to 1, to indicate a score which is not adequate.

An operator performs the process for determining if criteria for resizing an image is acceptable or not acceptable (447).

An operator updates Resize Criteria Rubric score in Resize Criteria Docu-Vault (7033) with a grade for the outcome of creating criteria for resizing an image is acceptable or not acceptable process (449).

An operator updates the Client Project Folio (7011) with a grade for the outcome of creating criteria for resizing an image (451).

An operator uses Resize Criteria Rubric (453).

If the Resize Criteria Rubric score is not adequate an operator creates new criteria (455).

If the Resize Criteria Rubric score is adequate an operator selects the Resize Criteria (457).

An operator assigns a unique identification number to a selected resize criteria (459).

The unique Identification Number incorporates a numeric chronological feature, and a multi-level and hierarchical sequence numbering feature.

An operator uploads a resize criteria to a Resize Criteria Docu-Vault (7033) (461).

An operator time stamps and updates the Client Project Folio with the date and time when a Resize Criteria was uploaded to the Resize Criteria Docu-Vault (7033) and an operator uploads the Resize criteria to a Resize Criteria Docu-Vault (7033) (461).

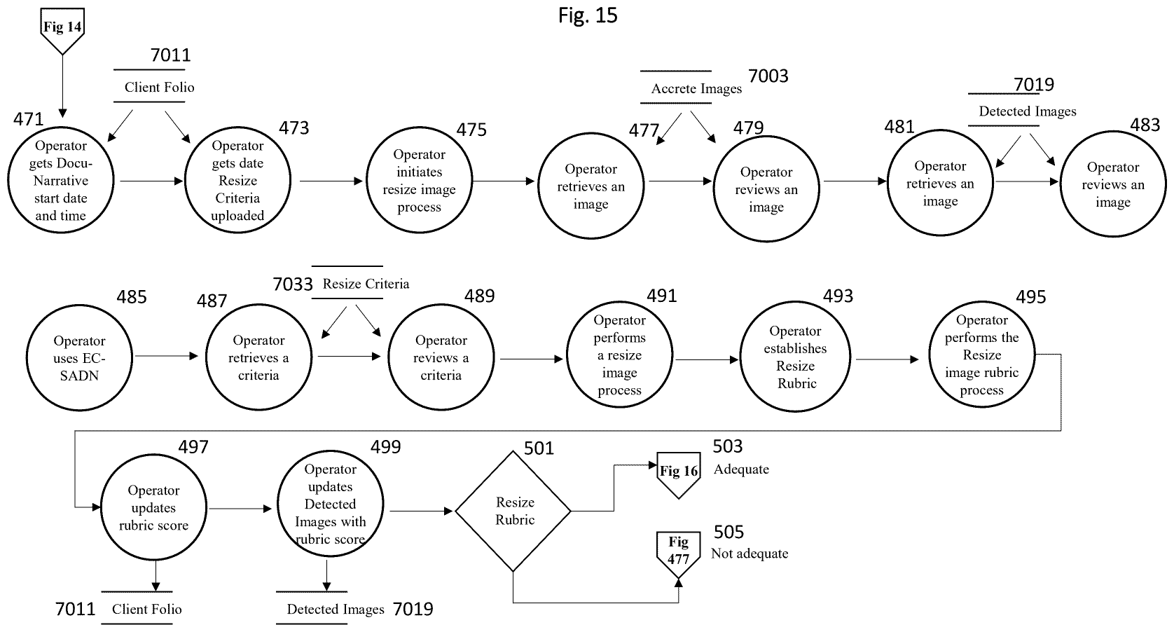

### FIG. 15 Method to Resize an Image

An operator retrieves the Docu-Narrative start date and time and the Docu-Narrative end date and time from the Client Project Folio (471).

An operator retrieves Client Project Folio with the date and time when the Resize Criteria and Rubric were uploaded to the Resize Criteria Docu-Vault (7033) (473).

An operator initiates a resize image process (475).

An operator retrieves an Accrete Image from an Accrete Images Docu-Vault (7003) (477).

An operator reviews an Accrete Image from an Accrete Images Docu-Vault (7003) (479.)

An operator retrieves a Target Object Waif Artifact image from a Detected Images Docu-Vault (7019) (481).

An operator reviews a Target Object Waif Artifact image from a Detected Images Docu-Vault (7019) (483).

An operator uses an EC-SADNEC-SADN Instruction Set and procedure to select Accrete Images to resize a Target Object Waif Artifact image into an image of its entirety (485).

An operator retrieves a Resize Criteria from a Resize Criteria Docu-Vault (7033) (487).

An operator reviews a Resize Criteria from a Resize Criteria Docu-Vault (7033) (489).

An operator uses an EarthCam proprietary EC-SADN Instruction Set to perform a process to accrete and/or resize the following images but not limited to accrete and/or resize the following images: an image, a Target Object Waif Artifact image, or an accreted image (491).

### Resize Rubric

An operator establishes a Resize Rubric (501), rules, and algorithm for determining if resizing an image is acceptable (493).

The rubric may be metric, digital, subjective or any combination. The rubric, rules, and algorithm provide the operator with a method for grading the outcome of resizing an image being acceptable or not acceptable and determining if the Resize Rubric score is acceptable.

An operator uses a value of 10 but not limited to 10, to indicate a score which is acceptable. An operator uses a value of 1 but not limited to 1, to indicate a score which is not adequate.

An operator performs the process for determining if resizing an image is acceptable or not acceptable. (495).

An operator updates the Client Project Folio (7011) with a grade for the outcome of resizing an image (497).

An operator updates a Resize Rubric score in Detected Images Docu-Vault (7019) with a grade for the outcome of resizing an image (499).

An operator uses Resize Rubric (501).

If the Resize Rubric score is not adequate an operator acquires another image (505).

If the Resize Rubric score is adequate, an EarthCam proprietary EC-SADN Instruction Set creates a child image record from the parent image record (503).

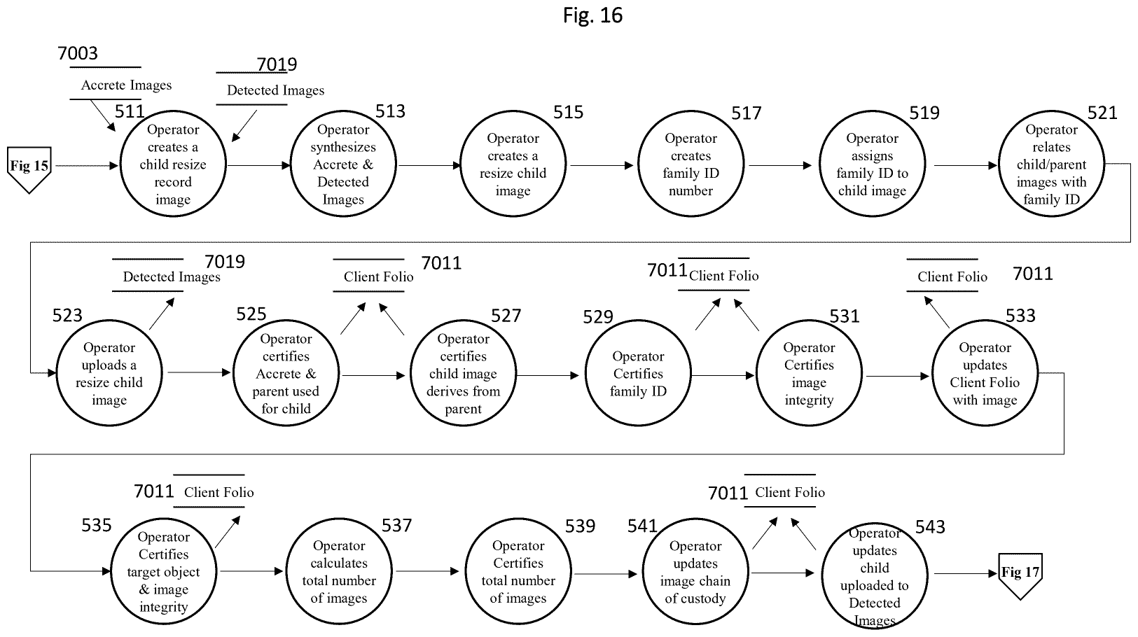

### FIG. 16 Method to Create a Resized Child Image

If the Resize Rubric score is adequate, an Operator uses an EarthCam proprietary EC-SADN Instruction Set to create a child resize image record from the parent image record (511).

The child record is a synthesized, accreted duplicate of the parent record (513).

An operator creates a child resize image with a unique identification number (515). The unique Identification Number incorporates a numeric chronological feature, and a multi-level and hierarchical sequence numbering feature.

An operator creates a unique family identification number (517). The unique Family Identification Number incorporates a numeric chronological feature, and a multi-level and hierarchical sequence numbering feature. The child record is related to the parent record by use of a family identification number associated with the Client Identification Number and, Client Location Identification Number and the Docu-narrative start date and time and the Docu-Narrative end date and time.

An operator assigns a unique family identification number to a child image (519).

An operator relates a child image to a parent image with a unique family identification number (521).

An operator uploads a child resize record to a Detected Image Docu-Vault (523).

An operator certifies and updates the Client Project Folio (7011) with a two-level certification identifying a parent image and an Accrete Image applied to a child image (525)

An operator certifies and updates the Client Project Folio (7011) with a two-level certification identifying the child images created for each parent image is derived from a parent image and the family identification number used (527).

An operator uses an EarthCam proprietary EC-SADN Instruction Set and an EarthCam proprietary procedure to ensure images from the start date and time of the Docu-Narrative to the end date and time of the Docu-Narrative have not been altered, concealed, falsified, or destroyed (531).

An operator updates the Client Project Folio (7011) that images have not been altered, concealed, falsified, or destroyed (533).

An operator authenticates and certifies and updates the Client Project Folio (7011) with an image and a Target Object Waif Artifact image has not been altered, concealed, falsified, or destroyed by providing a two-level certification (535).

An operator uses an EarthCam proprietary EC-SADN Instruction Set and an EarthCam proprietary procedure to calculate the total number of images with an image creation date between the start date and time of the Docu-Narrative and the end date and time of the Docu-Narrative (537).

An operator certifies and updates the Client Project Folio (7011) with the total number of images with an image creation date between the start date and time of the Docu-Narrative and the end date and time of the Docu-Narrative (539).

An operator time stamps and updates the Client Project Folio (7011) with a two-level certification and authentication for an image chain of custody including, but is not limited to including, an image identification number, Docu-Vault storage identification, and a date and time for an evidentiary quality image creation, image accretion, image maintenance, image recording and image logging process (541).

An operator time stamps and updates the Client Project Folio with the date and time when a Child Image was copied to the Detected Images Docu-Vault (7019) (543).

### Process to Accrete an Image

A process to accrete an image including but not limited to the following processes and methods:
Process to determine how much noise to change in an image.
Process to determine how much blur to change in an image.
Process to determine how much contrast to change in an image.
Process to determine how much saturation to change in an image.
Process to determine how much missing artifact part to change or add in an image.
Process to determine if accreting is finished.

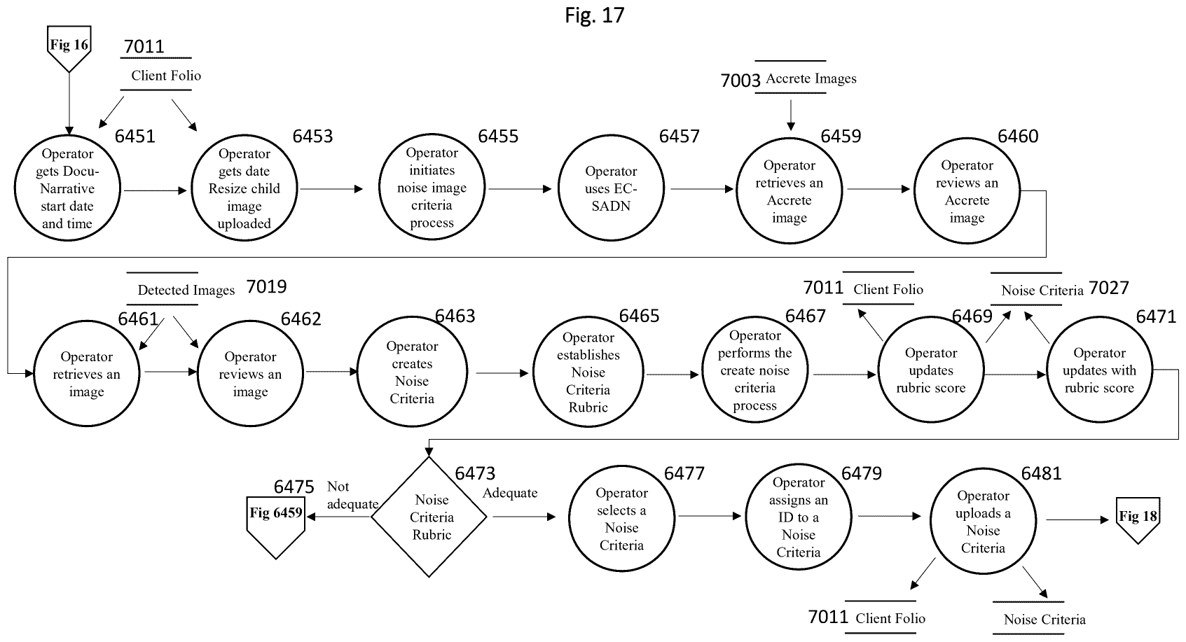

### FIG. 17 Method to Create Criteria for Noise in an Image

Method to determine how much noise to change in an image. The noise includes, but is not limited to including, the number of pixels high, pixels wide, pixel color, luminance noise, chrominance noise, and banding noise.

An operator retrieves the Docu-Narrative start date and time and the Docu-Narrative end date and time from the Client Project Folio (6451).

An operator retrieves Client Project Folio with the date and time when an operator uploads a resize image to an Accrete Images Docu-Vault (7003) (6453).

An operator initiates a process to create criteria for selecting Accrete Images from, but not limited from including images from, EarthCam proprietary Curated Images Docu-Vault (7017) and from third party Accrete Image datastores (6455).

An operator uses an EarthCam proprietary EarthCam-Software Algorithms for a Docu-Narrative instruction set to determine the criteria for noise in an image. The noise criteria includes, but are not limited to including, the number of pixels high, pixels wide, pixel color, luminance noise, chrominance noise, and banding noise (4657).

An operator retrieves an Accrete Image from an Accrete Images Docu-Vault (7003) (6459).

An operator reviews an Accrete Image from an Accrete Images Docu-Vault (7003) (6460).

An operator retrieves an image or Target Object Waif Artifact image from a Detected Images Docu-Vault (7019) (6461).

An operator reviews an image or Target Object Waif Artifact accreted image from a Detected Images Docu-Vault (7019) (4662).

An operator creates a Noise Criteria (6463).

An operator establishes a Noise Criteria Rubric (6473), rules, and algorithm for creating criteria for noise in an image which produces an acceptable image (6465).

The rubric may be metric, digital, subjective or any combination. The rubric, rules, and algorithms provide the operator with a method for grading the outcome to determine if criteria for noise in an image is acceptable or not acceptable and determining if the Noise Criteria Rubric score is acceptable.

An operator uses a value of 10 but not limited to 10, to indicate a score which is acceptable. An operator uses a value of 1 but not limited to 1, to indicate a score which is not adequate.

An operator performs the process for determining if criteria for noise in an image is acceptable or not acceptable (6467).

An operator updates Noise Criteria Rubric score in a Noise Criteria Docu-Vault (7027) with a grade for the outcome of creating criteria for noise in an image is acceptable or not acceptable process. (469)

An operator updates the Client Project Folio (7011) with a grade for the outcome of creating criteria for noise in an image (6471).

An operator uses a Noise Criteria Rubric (6473).

If the Noise Criteria Rubric score is not adequate an operator creates new criteria (6475).

If the Noise Criteria Rubric score is adequate an operator selects the Noise Criteria (6477).

An operator assigns a unique identification number to selected Noise criteria (6479).

The unique Identification Number incorporates a numeric chronological feature, and a multi-level and hierarchical sequence numbering feature.

An operator uploads Noise criteria to a Noise Criteria Docu-Vault (7027) and an operator time stamps and updates the Client Project Folio with the date and time when a Noise Criteria was uploaded to the Noise Criteria Docu-Vault (7027) and an operator uploads the Noise criteria to a Noise Criteria Docu-Vault (7027) (6481).

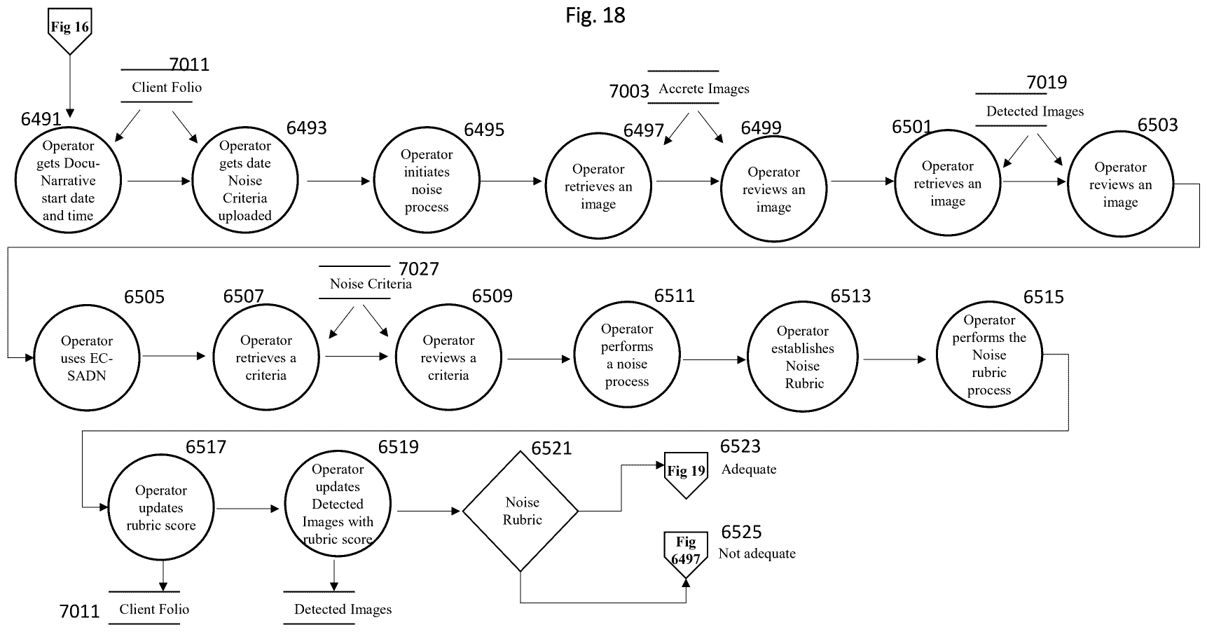

### FIG. 18 Method to Change Noise in an Image

An operator retrieves the Docu-Narrative start date and time and the Docu-Narrative end date and time from the Client Project Folio (6491).

An operator retrieves Client Project Folio with the date and time when the Noise Criteria and Rubric were uploaded to the Noise Criteria Docu-Vault (7027) (6493).

An operator initiates a noise image process (6495).

An operator retrieves an Accrete Image from an Accrete Images Docu-Vault (7003) (6497).

An operator reviews an Accrete Image from an Accrete Images Docu-Vault (7003) (6499).

An operator retrieves an image or Target Object Waif Artifact image from a Detected Images Docu-Vault (7019) (6501).

An operator reviews an image or Target Object Waif Artifact image from a Detected Images Docu-Vault (7019) (6503).

An operator uses an EC-SADN Instruction Set and procedure to select Accrete Images for noise to a Target Object Waif Artifact image into an image of its entirety (6505).

An operator retrieves a Noise Criteria from a Noise Criteria Docu-Vault (7027) (6507).

An operator reviews a Noise Criteria from a Noise Criteria Docu-Vault (7027) (6509).

An operator uses an EarthCam proprietary EC-SADN Instruction Set to perform a process for noise to the following images but not limited to the following images: an image, a Target Object Waif Artifact image, or an accreted image (6511).

### Noise Rubric

An operator establishes a Noise Rubric, (6521) rules, and algorithm for determining if noise for an image is acceptable (6513).

The rubric may be metric, digital, subjective or any combination. The rubric, rules, and algorithm provide the operator with a method for grading the outcome of noise for an image being acceptable or not acceptable and determining if the Noise Rubric score is acceptable.

An operator uses a value of 10 but not limited to 10, to indicate a score which is acceptable. An operator uses a value of 1 but not limited to 1, to indicate a score which is not adequate.

An operator performs the process for determining if noise for an image is acceptable or not acceptable (6515).

An operator updates the Client Project Folio (7011) with a grade for the outcome of noise for an image (6517).

An operator updates a Noise Rubric score in Detected Images Docu-Vault (7019) with a grade for the outcome of noise for an image (6519).

An operator uses a Noise Rubric (6521).

If the Noise Rubric score is not adequate an operator acquires another image (6525).

If the Noise Rubric score is adequate, an EarthCam proprietary EC-SADN Instruction Set creates a child image record from the parent image record (6523).

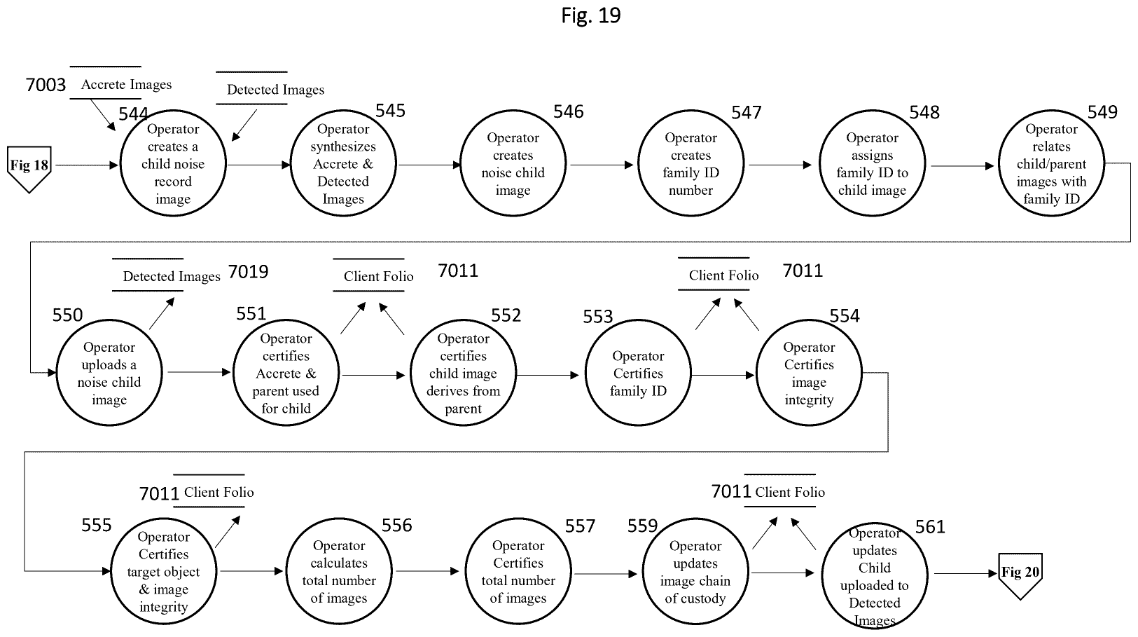

FIG. 19 Method to Create a Child Image with the Noise Change

If the Noise Rubric score is adequate, an Operator uses an EarthCam proprietary EC-SADN Instruction Set to create a child noise image record from the parent image record (544).

The child record is a synthesized, accreted duplicate of the parent record (545)

An operator creates a child noise image with a unique identification number (546). The unique Identification Number incorporates a numeric chronological feature, and a multi-level and hierarchical sequence numbering feature.

An operator creates a unique family identification number (547). The unique Family Identification Number incorporates a numeric chronological feature, and a multi-level and hierarchical sequence numbering feature. The child record is related to the parent record by use of a family identification number associated with the Client Identification Number and, Client Location Identification Number and the Docu-narrative start date and time and the Docu-Narrative end date and time.

An operator assigns a unique family identification number to a child image (548).

An operator relates a child image to a parent image with a unique family identification number (549).

An operator uploads a child noise record to a Detected Image Docu-Vault (550).

An operator certifies and updates the Client Project Folio (7011) with a two-level certification identifying a parent image and an accrete image applied to a child image (551).

An operator certifies and updates the Client Project Folio (7011) with a two-level certification identifying the child images created for each parent image is derived from a parent image and the family identification number used (552).

An operator authenticates and certifies and updates the Client Project Folio (7011) with a family identification number for an image and a Target Object Waif Artifact image and that they are unique to the family images (553).

An operator uses an EarthCam proprietary EC-SADN Instruction Set and an EarthCam proprietary procedure to ensure image integrity from the start date and time of the Docu-Narrative to the end date and time of the Docu-Narrative have not been altered, concealed, falsified, or destroyed (554).

An operator authenticates and certifies and updates the Client Project Folio (7011) to ensure the integrity of an image and a Target Object Waif Artifact image has not been altered, concealed, falsified, or destroyed by providing a two-level certification (555).

An operator uses an EarthCam proprietary EC-SADN Instruction Set and an EarthCam proprietary procedure to calculate the total number of images with an image creation date between the start date and time of the Docu-Narrative and the end date and time of the Docu-Narrative (556).

An operator certifies and updates the Client Project Folio (7011) with the total number of images with an image creation date between the start date and time of the Docu-Narrative and the end date and time of the Docu-Narrative (557).

An operator time stamps and updates the Client Project Folio (7011) with a two-level certification and authentication for an image chain of custody including, but is not limited to including, an image identification number, Docu-Vault storage identification, and a date and time for an evidentiary quality image creation, image accretion, image maintenance, image recording and image logging process (559).

An operator time stamps and updates the Client Project Folio with the date and time when a Child Image was copied to the Detected Images Docu-Vault (7019) (561).

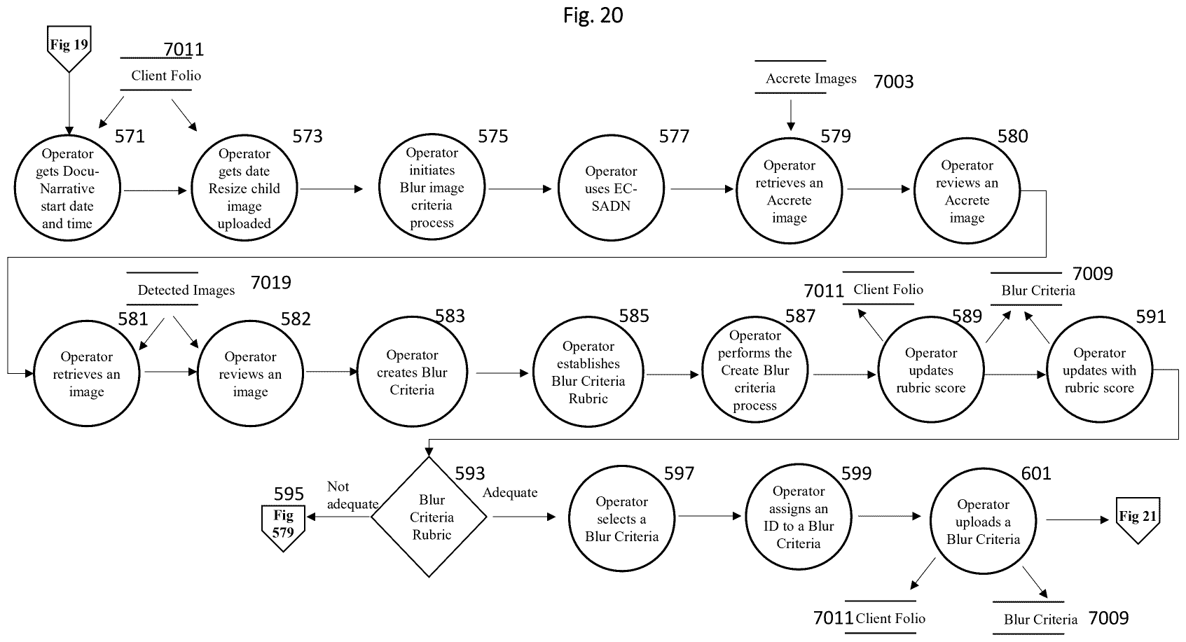

### FIG. 20 Method to Create Criteria for Blur in an Image

Method to determine how much blur to, but not limited to adding, hiding, or changing in an image.

Blur an image may make, but not limited to making, an image less sharp and may reduce the level of detail, clarity or sharpness in an image. Blur distorts, but is not limited to distorting, the detail of an image, its clarity or its sharpness which makes it less clear. The loss of clarity, but not limited to clarity, sharpness or detail in a photographic image may result from, but not limited to resulting from, a motion of a subject or motion of a camera.

An operator retrieves the Docu-Narrative start date and time and the Docu-Narrative end date and time from the Client Project Folio (571).

An operator retrieves Client Project Folio with the date and time when an operator uploads a noise image to an Accrete Images Docu-Vault (7003) (573).

An operator initiates a process to create criteria for selecting Accrete Images from, but not limited from including images from, EarthCam proprietary Curated Images Docu-Vault (7017) and from third party accrete image datastores (575).

An operator uses an EarthCam proprietary EarthCam-Software Algorithms for a Docu-Narrative Instruction set to determine the criteria for blur in an image. The blur criteria includes blur from, but not limited to blur resulting from, a motion of a subject or motion of a camera (577).

An operator retrieves an Accrete Image from an Accrete Images Docu-Vault (7003) (579).

An operator reviews an Accrete Image from an Accrete Images Docu-Vault (7003) (580).

An operator retrieves an image or Target Object Waif Artifact image from a Detected Images Docu-Vault (7019) (581).

An operator reviews an image or Target Object Waif Artifact accreted image from a Detected Images Docu-Vault (7019) (582).

An operator creates a Blur Criteria (583).

An operator establishes a Blur Criteria Rubric (593), rules, and algorithm for creating criteria for blur in an image which produces an acceptable image (585).

The rubric may be metric, digital, subjective or any combination. The rubric, rules, and algorithm provide the operator with a method for grading the outcome to determine if criteria for blur in an image is acceptable or not acceptable and determining if the Blur Criteria Rubric score is acceptable.

An operator uses a value of 10 but not limited to 10, to indicate a score which is acceptable. An operator uses a value of 1 but not limited to 1, to indicate a score which is not adequate.

An operator performs the process for determining if criteria for blur in an image is acceptable or not acceptable (587).

An operator updates Blur Criteria Rubric score in a Blur Criteria Docu-Vault (7009) with a grade for the outcome of creating criteria for blur in an image is acceptable or not acceptable process. (589)

An operator updates the Client Project Folio (7011) with a grade for the outcome of creating criteria for Blur in an image (591).

An operator uses a Blur Criteria Rubric (593).

If the Blur Criteria Rubric score is not adequate an operator creates new criteria (595).

If the Blur Criteria Rubric score is adequate an operator selects the Blur Criteria (597).

An operator assigns a unique identification number to a selected Accrete Image (599).

The unique Identification Number incorporates a numeric chronological feature, and a multi-level and hierarchical sequence numbering feature.

An operator uploads blur criteria to a Blur Criteria Docu-Vault (7009) and an operator time stamps and updates the Client Project Folio with the date and time when a Blur Criteria was uploaded to the Blur Criteria Docu-Vault (7009) (601).

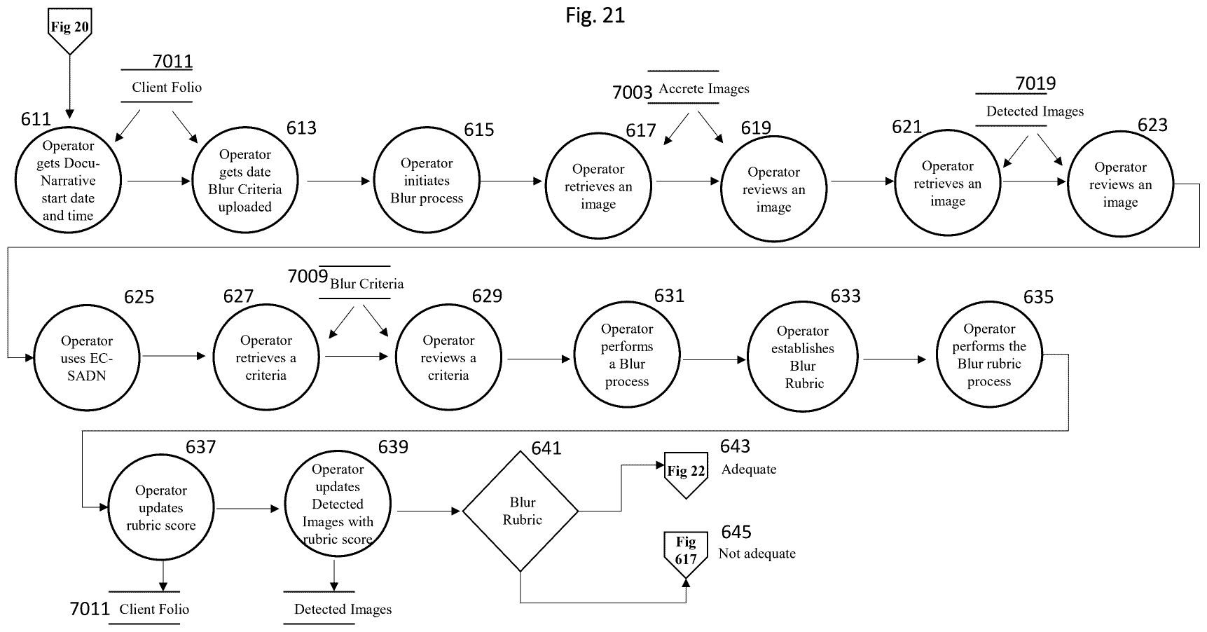

### FIG. 21 Method to Change Blur in an Image

An operator retrieves the Docu-Narrative start date and time and the Docu-Narrative end date and time from the Client Project Folio (611).

An operator retrieves Client Project Folio with the date and time when the Blur Criteria and Rubric were uploaded to the Blur Criteria Docu-Vault (7009) (613).

An operator initiates a Blur image process (615).

An operator retrieves an Accrete Image from an Accrete Images Docu-Vault (7003) (617).

An operator reviews an Accrete Image from an Accrete Images Docu-Vault (7003) (619).

An operator retrieves an image or Target Object Waif Artifact image from a Detected Images Docu-Vault (7019) (621).

An operator reviews an image or Target Object Waif Artifact image from a Detected Images Docu-Vault (7019) (623).

An operator uses an EC-SADN Instruction Set and procedure to select Accrete Images for blur to a Target Object Waif Artifact image into an image of its entirety (625).

An operator retrieves Blur Criteria from a Blur Criteria Docu-Vault (7009) (627).

An operator reviews a Blur Criteria from a Blur Criteria Docu-Vault (7009) (629).

An operator uses an EarthCam proprietary EC-SADN Instruction Set to perform a process for blur to the following images but not limited to the following images: an image, a Target Object Waif Artifact image, or an accreted image (631).

An operator establishes a Blur Rubric, (641) rules, and algorithm for determining if blur for an image is acceptable (633).

The rubric may be metric, digital, subjective or any combination. The rubric, rules, and algorithm provide the operator with a method for grading the outcome of blur for an image being acceptable or not acceptable and determining if the Blur Rubric score is acceptable.

An operator uses a value of 10 but not limited to 10, to indicate a score which is acceptable. An operator uses a value of 1 but not limited to 1, to indicate a score which is not adequate.

An operator performs the process for determining if blur for an image is acceptable or not acceptable (635).

An operator updates the Client Project Folio (7011) with a grade for the outcome of blur for an image (637).

An operator updates a Blur Rubric score in Detected Images Docu-Vault (7019) with a grade for the outcome of blur for an image (639).

An operator uses a Blur Rubric (641).

If the Blur Rubric score is not adequate an operator acquires another image (645).

If the Blur Rubric score is adequate, an EarthCam proprietary EC-SADN Instruction Set creates a child image record from the parent image record (643).

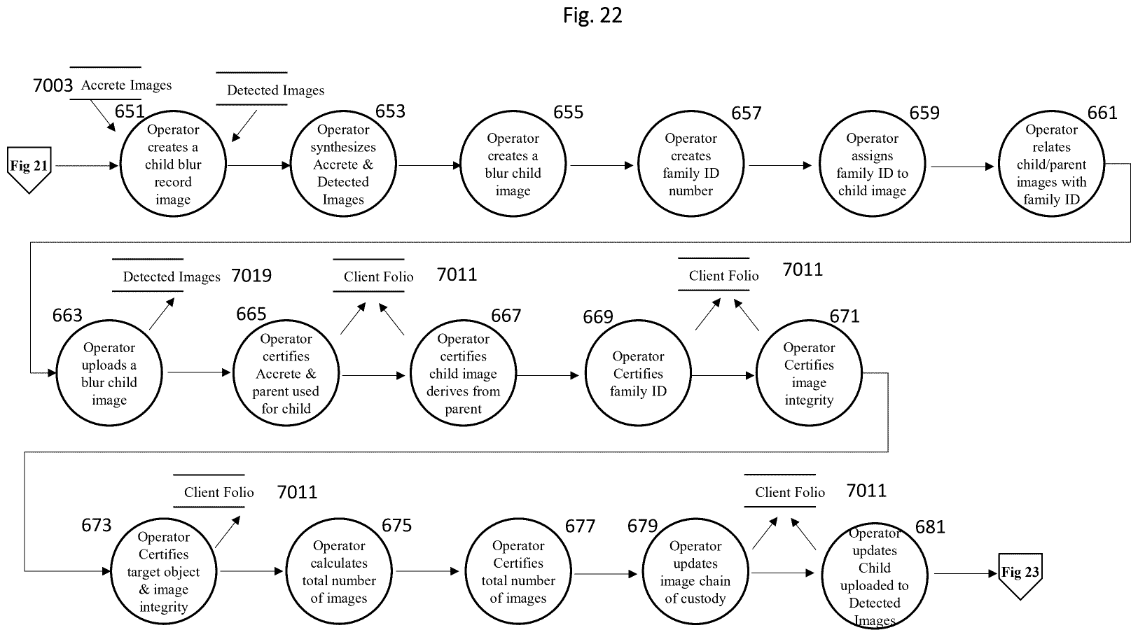

FIG. 22 Method to Create a Child Image with the Blur Change

If the Blur Rubric score is adequate, an Operator uses an EarthCam proprietary EC-SADN Instruction Set to create a child blur image record from the parent image record (651).

The child record is a synthesized, accreted duplicate of the parent record (653).

An operator creates a child blur image with a unique identification number (655). The unique Identification Number incorporates a numeric chronological feature, and a multi-level and hierarchical sequence numbering feature.

An operator creates a unique family identification number (657). The unique Family Identification Number incorporates a numeric chronological feature, and a multi-level and hierarchical sequence numbering feature. The child record is related to the parent record by use of a family identification number associated with the Client Identification Number and, Client Location Identification Number and the Docu-narrative start date and time and the Docu-Narrative end date and time.

An operator assigns a unique family identification number to a child image (659).

An operator relates a child image to a parent image with a unique family identification number. (661).

An operator uploads a blur child record to a Detected Image Docu-Vault (663).

An operator certifies and updates the Client Project Folio (7011) with a two-level certification identifying a parent image and an accrete image applied to a child image (665).

An operator certifies and updates the Client Project Folio (7011) with a two-level certification identifying the child images created for each parent image is derived from a parent image and the family identification number used (667).

An operator authenticates and certifies and updates the Client Project Folio (7011) with a family identification number for an image and a Target Object Waif Artifact image and that they are unique to the family images (669).

An operator uses an EarthCam proprietary EC-SADN Instruction Set and an EarthCam proprietary procedure to ensure image integrity from the start date and time of the Docu-Narrative to the end date and time of the Docu-Narrative have not been altered, concealed, falsified, or destroyed (671).

An operator authenticates and certifies and updates the Client Project Folio (7011) to ensure the integrity of an image and a Target Object Waif Artifact image has not been altered, concealed, falsified, or destroyed by providing a two-level certification (673).

An operator uses an EarthCam proprietary EC-SADN Instruction Set and an EarthCam proprietary procedure to calculate the total number of images with an image creation date between the start date and time of the Docu-Narrative and the end date and time of the Docu-Narrative (675).

An operator certifies and updates the Client Project Folio (7011) with the total number of images with an image creation date between the start date and time of the Docu-Narrative and the end date and time of the Docu-Narrative (677).

An operator time stamps and updates the Client Project Folio (7011) with a two-level certification and authentication for an image chain of custody including, but is not limited to including, an image identification number, Docu-Vault storage identification, and a date and time for an evidentiary quality image creation, image accretion, image maintenance, image recording and image logging process (679).

An operator time stamps and updates the Client Project Folio with the date and time when a Child Image was copied to the Detected Images Docu-Vault (7019) (681).

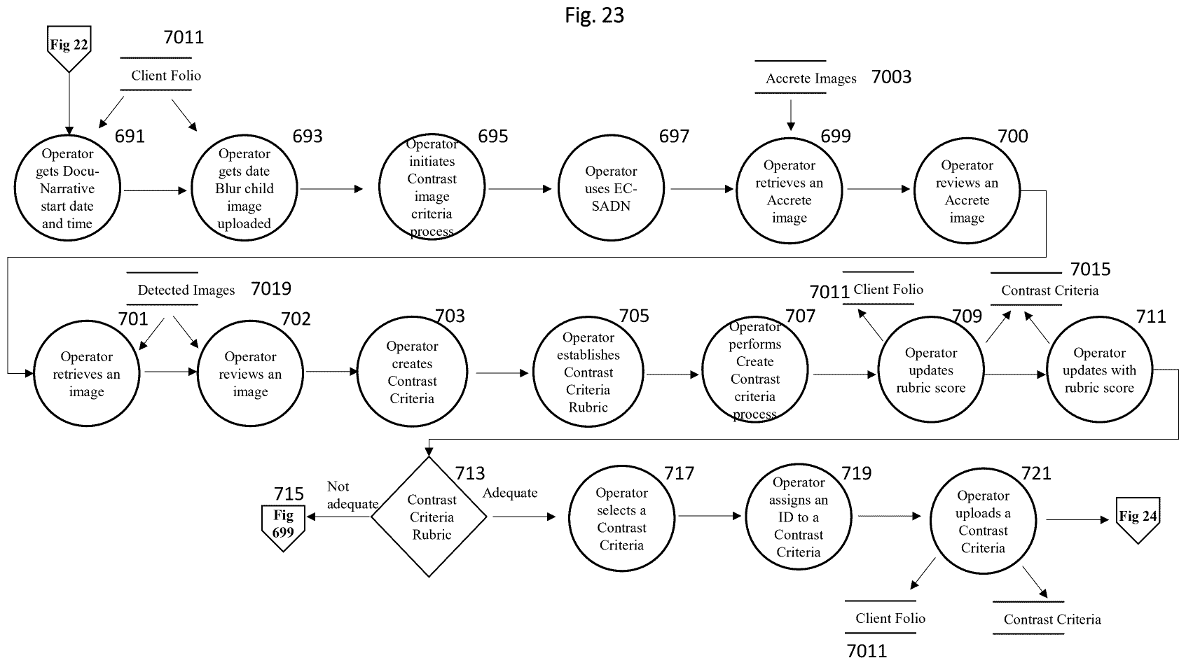

### FIG. 23 Method to Create Criteria for Contrast in an Image

A process to determine how much contrast to change in an image. A process to change a visual ratio of different tones in an image to create, but limited to creating changes in textures, highlights, shadows, colors, and clarity in an image.

An operator retrieves the Docu-Narrative start date and time and the Docu-Narrative end date and time from the Client Project Folio (691).

An operator retrieves Client Project Folio with the date and time when an operator uploads a blur image to an Accrete Images Docu-Vault (7003) (693).

An operator initiates a process to create criteria for selecting Accrete Images from, but not limited from including images from, EarthCam proprietary Curated Images Docu-Vault (7017) and from third party accrete image datastores (695).

An operator uses an EarthCam proprietary EarthCam-Software Algorithms for a Docu-Narrative Instruction set to determine the criteria for contrast in an image. The contrast criteria includes, but are not limited to including, a change for a visual ratio of different tones in an image to create, but limited to creating changes in textures, highlights, shadows, colors, and clarity in an image (697).

An operator retrieves an Accrete Image from an Accrete Images Docu-Vault (7003) (699).

An operator reviews an Accrete Image from an Accrete Images Docu-Vault (7003) (700).

An operator retrieves an image or Target Object Waif Artifact image from a Detected Images Docu-Vault (7019) (701).

An operator reviews an image or Target Object Waif Artifact accrete image from a Detected Images Docu-Vault (7019) (702).

An operator creates a Contrast Criteria (703).

An operator establishes a Contrast Criteria Rubric (713), rules, and algorithm for creating criteria for determining if contrast in an image which produces an acceptable image (705).

The rubric may be metric, digital, subjective or any combination. The rubric, rules, and algorithm provide the operator with a method for grading the outcome to determine if criteria for contrast in an image is acceptable or not acceptable and determining if the Contrast Criteria Rubric score is acceptable.

An operator uses a value of 10 but not limited to 10, to indicate a score which is acceptable. An operator uses a value of 1 but not limited to 1, to indicate a score which is not adequate.

An operator performs the process for determining if criteria for contrast in an image is acceptable or not acceptable (707).

An operator updates Contrast Criteria Rubric score in a Contrast Criteria Docu-Vault (7015) with a grade for the outcome of creating criteria for contrast in an image is acceptable or not acceptable process (709).

An operator updates the Client Project Folio (7011) with a grade for the outcome of creating criteria for contrast in an image (711).

An operator uses a Contrast Criteria Rubric (713).

If a Contrast Criteria Rubric score is not adequate, an operator creates new criteria (715).

If a Contrast Criteria Rubric score is adequate an operator selects the Contrast Criteria (717).

An operator assigns a unique identification number to a selected Contrast criteria (719).

The unique Identification Number incorporates a numeric chronological feature, and a multi-level and hierarchical sequence numbering feature.

An operator uploads Contrast criteria to a Contrast Criteria Docu-Vault (7015) and an operator time stamps and updates the Client Project Folio with the date and time when a Contrast Criteria was uploaded to the Contrast Criteria Docu-Vault (7015) and an operator uploads the Contrast criteria to a Contrast Criteria Docu-Vault (7015). (721).

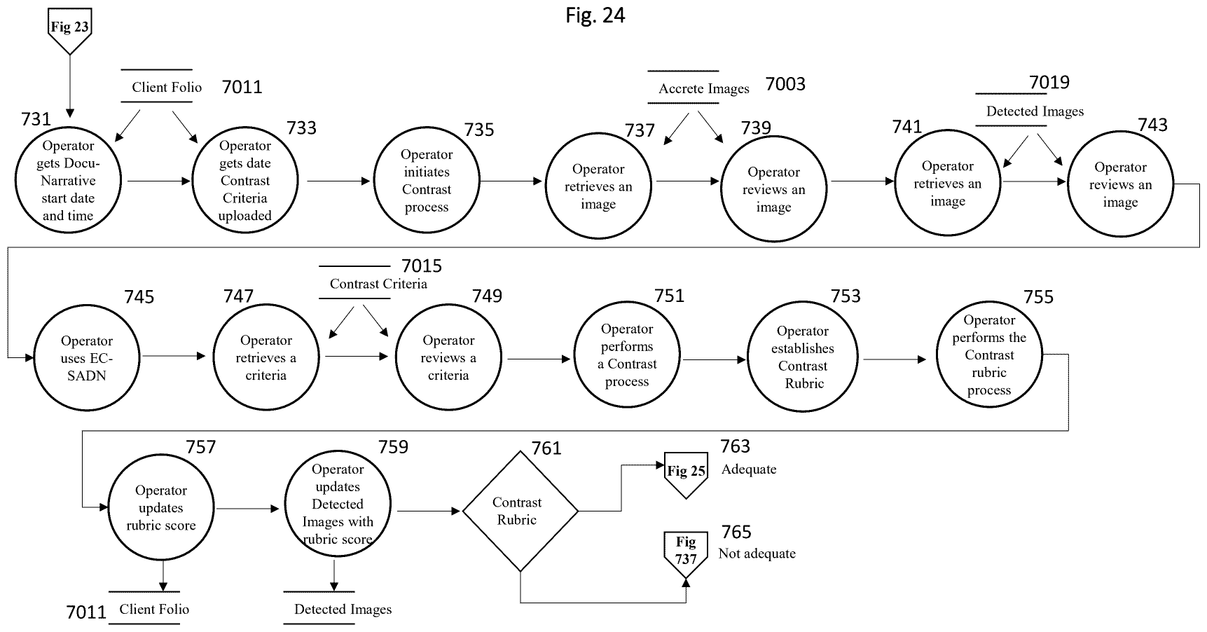

### FIG. 24 Method to Change Contrast in an Image

An operator retrieves the Docu-Narrative start date and time and the Docu-Narrative end date and time from the Client Project Folio (731).

An operator retrieves Client Project Folio with the date and time when the Contrast Criteria and Rubric were uploaded to the Contrast Criteria Docu-Vault (7015) (733).

An operator initiates a Contrast image process (735).

An operator retrieves an Accrete Image from an Accrete Images Docu-Vault (7003) (737).

An operator reviews an Accrete Image from an Accrete Images Docu-Vault (7003) (739).

An operator retrieves an image or Target Object Waif Artifact image from a Detected Images Docu-Vault (7019) (741).

An operator reviews an image or Target Object Waif Artifact image from a Detected Images Docu-Vault (7019) (743).

An operator uses an EC-SADN Instruction Set and procedure to select Accrete Images for contrast to a Target Object Waif Artifact image into an image of its entirety (745).

An operator retrieves a Contrast Criteria from a Contrast Criteria Docu-Vault (7015) (747).

An operator reviews a Contrast Criteria from a Contrast Criteria Docu-Vault (7015) (749).

An operator uses an EarthCam proprietary EC-SADN Instruction Set to perform a process for contrast to the following images but not limited to the following images: an image, a Target Object Waif Artifact image, or an accreted image (751).

An operator establishes a Contrast Rubric, (761) rules, and algorithm for determining if contrast for an image is acceptable (753).

The rubric may be metric, digital, subjective or any combination. The rubric, rules, and algorithm provide the operator with a method for grading the outcome of contrast for an image being acceptable or not acceptable and determining if the Contrast Rubric score is acceptable.

An operator uses a value of 10 but not limited to 10, to indicate a score which is acceptable. An operator uses a value of 1 but not limited to 1, to indicate a score which is not adequate.

An operator performs the process for determining if contrast for an image is acceptable or not acceptable (755).

An operator updates the Client Project Folio (7011) with a grade for the outcome of contrast for an image (757).

An operator updates a Contrast Rubric score in Detected Images Docu-Vault (7019) with a grade for the outcome of contrast for an image (759).

An operator uses a Contrast Rubric (761).

If the Contrast Rubric score is not adequate an operator acquires another image (765).

If the Contrast Rubric score is adequate, an EarthCam proprietary EC-SADN Instruction Set creates a child image record from the parent image record (763).

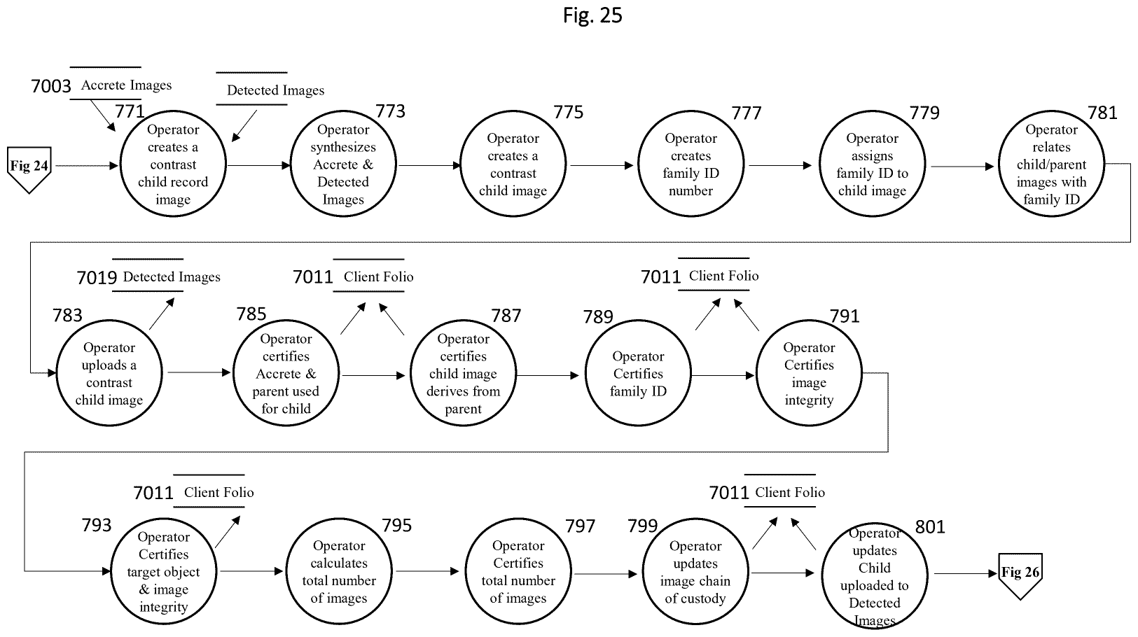

FIG. 25 Method to Create a Child Image with the Contrast Change

If the Contrast Rubric score is adequate, an Operator uses an EarthCam proprietary EC-SADN Instruction Set to create a child contrast image record from the parent image record (771).

The child record is a synthesized, accreted duplicate of the parent record (773).

An operator creates a child contrast image with a unique identification number (775). The unique Identification Number incorporates a numeric chronological feature, and a multi-level and hierarchical sequence numbering feature.

An operator creates a unique family identification number (777). The unique Family Identification Number incorporates a numeric chronological feature, and a multi-level and hierarchical sequence numbering feature. The child record is related to the parent record by use of a family identification number associated with the Client Identification Number and, Client Location Identification Number and the Docu-narrative start date and time and the Docu-Narrative end date and time.

An operator assigns a unique family identification number to a child image (779).

An operator relates a child image to a parent image with a unique family identification number (781).

An operator uploads a contrast child record to a Detected Image Docu-Vault (783).

An operator certifies and updates the Client Project Folio (7011) with a two-level certification identifying a parent image and an accrete image applied to a child image (785).

An operator certifies and updates the Client Project Folio (7011) with a two-level certification identifying the child images created for each parent image is derived from a parent image and the family identification number used (787).

An operator authenticates and certifies and updates the Client Project Folio (7011) with a family identification number for an image and a Target Object Waif Artifact image and that they are unique to the family images (789).

An operator uses an EarthCam proprietary EC-SADN Instruction Set and an EarthCam proprietary procedure to ensure image integrity from the start date and time of the Docu-Narrative to the end date and time of the Docu-Narrative have not been altered, concealed, falsified, or destroyed (791).

An operator authenticates and certifies and updates the Client Project Folio (7011) to ensure the integrity of an image and a Target Object Waif Artifact image has not been altered, concealed, falsified, or destroyed by providing a two-level certification (793).

An operator uses an EarthCam proprietary EC-SADN Instruction Set and an EarthCam proprietary procedure to calculate the total number of images with an image creation date between the start date and time of the Docu-Narrative and the end date and time of the Docu-Narrative (795).

An operator certifies and updates the Client Project Folio (7011) with the total number of images with an image creation date between the start date and time of the Docu-Narrative and the end date and time of the Docu-Narrative (797).

An operator time stamps and updates the Client Project Folio (7011) with a two-level certification and authentication for an image chain of custody including, but is not limited to including, an image identification number, Docu-Vault storage identification, and a date and time for an evidentiary quality image creation, image accretion, image maintenance, image recording and image logging process (799).

An operator time stamps and updates the Client Project Folio with the date and time when a Child Image was copied to the Detected Images Docu-Vault (7019) (801).

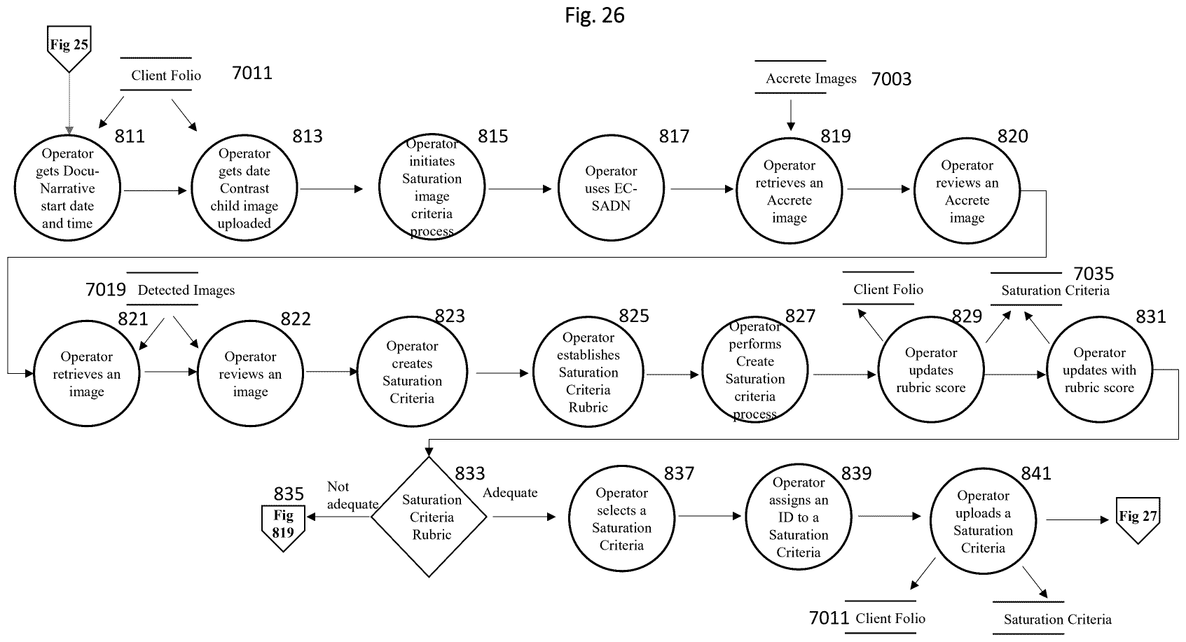

### FIG. 26 Method to Create Criteria for Saturation in an Image

A method to determine how much saturation to change in an image.

A process to change the intensity of color in an image to create, but limited to creating changes in colors, and clarity in an image.

An operator retrieves the Docu-Narrative start date and time and the Docu-Narrative end date and time from the Client Project Folio (811).

An operator retrieves Client Project Folio with the date and time when an operator uploads a contrast image to an Accrete Images Docu-Vault (7003) (813).

An operator initiates a process to create criteria for selecting Accrete Images from, but not limited from including images from, EarthCam proprietary Curated Images Docu-Vault (7017) and from third party accrete image datastores (815).

An operator uses an EarthCam proprietary EarthCam-Software Algorithms for a Docu-Narrative Instruction set to determine the criteria for saturation in an image. The saturation criteria includes, but are not limited to including, a change for a visual ratio of different tones in an image to create, but limited to creating changes in textures, highlights, shadows, colors, and clarity in an image (817).

An operator retrieves an Accrete Image from an Accrete Images Docu-Vault (7003) (819).

An operator reviews an Accrete Image from an Accrete Images Docu-Vault (7003) (820).

An operator retrieves an image or Target Object Waif Artifact image from a Detected Images Docu-Vault (7019) (821).

An operator reviews an image or Target Object Waif Artifact accreted image from a Detected Images Docu-Vault (7019) (822).

An operator creates a Saturation Criteria (823).

An operator establishes a Saturation Criteria Rubric (823), rules, and algorithm for creating criteria for saturation for an image which produces an acceptable image (825).

The rubric may be metric, digital, subjective or any combination. The rubric, rules, and algorithm provide the operator with a method for grading the outcome to determine if criteria for saturation in an image is acceptable or not acceptable and determining if the Saturation Criteria Rubric score is acceptable.

An operator uses a value of 10 but not limited to 10, to indicate a score which is acceptable. An operator uses a value of 1 but not limited to 1, to indicate a score which is not adequate.

An operator performs the process for determining if criteria for saturation in an image is acceptable or not acceptable (827).

An operator updates Saturation Criteria Rubric score in a Contrast Criteria Docu-Vault (7015) with a grade for the outcome of creating criteria for saturation in an image is acceptable or not acceptable process (829).

An operator updates the Client Project Folio (7011) with a grade for the outcome of creating criteria for saturation in an image (831).

An operator uses a Saturation Criteria Rubric (833).

If a Saturation Criteria Rubric score is not adequate, an operator creates new criteria (835).

If a Saturation Criteria Rubric score is adequate an operator selects the Saturation Criteria (837).

An operator assigns a unique identification number to a selected Saturation criteria (839).

The unique Identification Number incorporates a numeric chronological feature, and a multi-level and hierarchical sequence numbering feature.

An operator uploads a Saturation criteria to a Saturation Criteria Docu-Vault (7035) and an operator time stamps and updates the Client Project Folio with the date and time when a Saturation Criteria was uploaded to the Saturation Criteria Docu-Vault (7035) and an operator uploads the Saturation criteria to a Saturation Criteria Docu-Vault (7035) (841).

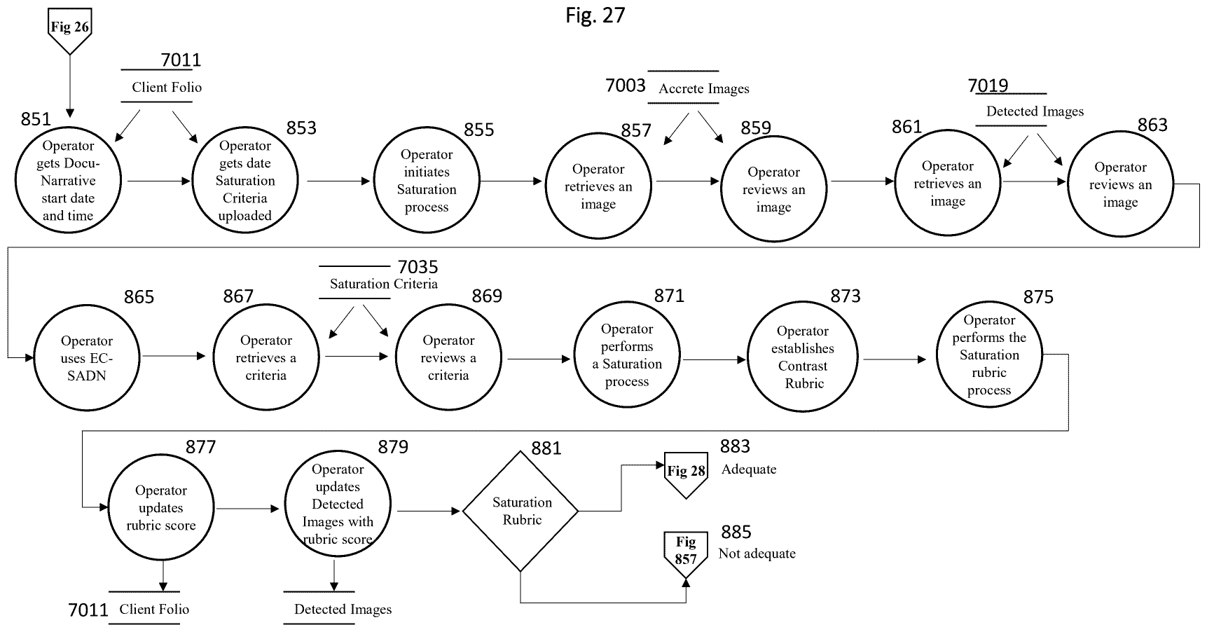

### FIG. 27 Method to Change Saturation in an Image

An operator retrieves the Docu-Narrative start date and time and the Docu-Narrative end date and time from the Client Project Folio (851).

An operator retrieves Client Project Folio with the date and time when the Saturation Criteria and Rubric were uploaded to the Saturation Criteria Docu-Vault (7035) (853).

An operator initiates a Saturation image process (855).

An operator retrieves an Accrete Image from an Accrete Images Docu-Vault (7003) (857).

An operator reviews an Accrete Image from an Accrete Images Docu-Vault (7003) (859).

An operator retrieves an image or Target Object Waif Artifact image from a Detected Images Docu-Vault (7019) (861).

An operator reviews an image or Target Object Waif Artifact image from a Detected Images Docu-Vault (7019) (863).

An operator uses an EC-SADN Instruction Set and procedure to select Accrete Images for saturation to a Target Object Waif Artifact image into an image of its entirety (865).

An operator retrieves a Contrast Criteria from a Contrast Criteria Docu-Vault (7015) (867).

An operator reviews a Contrast Criteria from a Contrast Criteria Docu-Vault (7015) (869).

An operator uses an EarthCam proprietary EC-SADN Instruction Set to perform a process for saturation to the following images but not limited to the following images: an image, a Target Object Waif Artifact image, or an accreted image (871).

An operator establishes a Saturation Rubric, (881) rules, and algorithm for determining if saturation for an image is acceptable (873).

The rubric may be metric, digital, subjective or any combination. The rubric, rules, and algorithm provide the operator with a method for grading the outcome of saturation for an image being acceptable or not acceptable and determining if the Saturation Rubric score is acceptable.

An operator uses a value of 10 but not limited to 10, to indicate a score which is acceptable. An operator uses a value of 1 but not limited to 1, to indicate a score which is not adequate.

An operator performs the process for determining if saturation for an image is acceptable or not acceptable (875).

An operator updates the Client Project Folio (7011) with a grade for the outcome of saturation for an image (877).

An operator updates a Saturation Rubric score in Detected Images Docu-Vault (7019) with a grade for the outcome of saturation for an image (879).

An operator uses a Saturation Rubric (881).

If the Saturation Rubric score is not adequate an operator acquires another image (885).

If the Saturation Rubric score is adequate, an EarthCam proprietary EC-SADN Instruction Set creates a child image record from the parent image record (883).

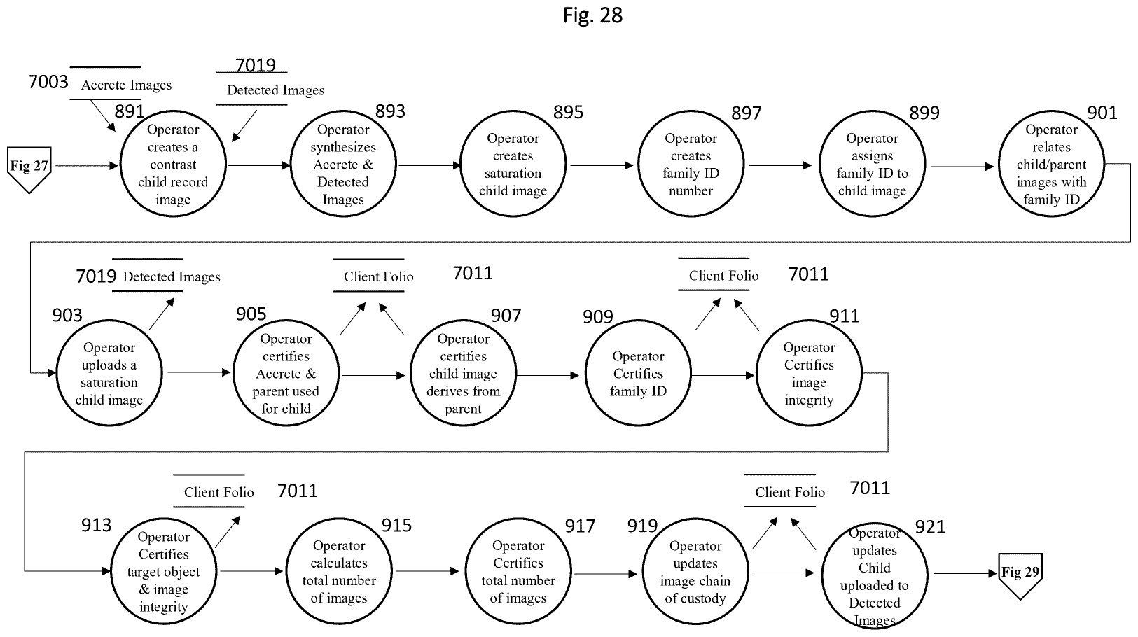

FIG. 28 Process to Create a Child Image with the Saturation Change

If the Contrast Rubric score is adequate, an Operator uses an EarthCam proprietary EC-SADN Instruction Set to create a child saturation image record from the parent image record (891).

The child record is a synthesized, accreted duplicate of the parent record (893).

An operator creates a child saturation image with a unique identification number (895). The unique Identification Number incorporates a numeric chronological feature, and a multi-level and hierarchical sequence numbering feature.

An operator creates a unique family identification number (897). The unique Family Identification Number incorporates a numeric chronological feature, and a multi-level and hierarchical sequence numbering feature. The child record is related to the parent record by use of a family identification number associated with the Client Identification Number and, Client Location Identification Number and the Docu-narrative start date and time and the Docu-Narrative end date and time.

An operator assigns a unique family identification number to a child image (899).

An operator relates a child image to a parent image with a unique family identification number. (901).

An operator uploads a contrast child record to a Detected Image Docu-Vault (903).

An operator certifies and updates the Client Project Folio (7011) with a two-level certification identifying a parent image and an accrete image applied to a child image (905).

An operator certifies and updates the Client Project Folio (7011) with a two-level certification identifying the child images created for each parent image is derived from a parent image and the family identification number used (907).

An operator authenticates and certifies and updates the Client Project Folio (7011) with a family identification number for an image and a Target Object Waif Artifact image and that they are unique to the family images (909).

An operator uses an EarthCam proprietary EC-SADN Instruction Set and an EarthCam proprietary procedure to ensure image integrity from the start date and time of the Docu-Narrative to the end date and time of the Docu-Narrative have not been altered, concealed, falsified, or destroyed (911).

An operator authenticates and certifies and updates the Client Project Folio (7011) to ensure the integrity of an image and a Target Object Waif Artifact image has not been altered, concealed, falsified, or destroyed by providing a two-level certification (913).

An operator uses an EarthCam proprietary EC-SADN Instruction Set and an EarthCam proprietary procedure to calculate the total number of images with an image creation date between the start date and time of the Docu-Narrative and the end date and time of the Docu-Narrative (915).

An operator certifies and updates the Client Project Folio (7011) with the total number of images with an image creation date between the start date and time of the Docu-Narrative and the end date and time of the Docu-Narrative (917).

An operator time stamps and updates the Client Project Folio (7011) with a two-level certification and authentication for an image chain of custody including, but is not limited to including, an image identification number, Docu-Vault storage identification, and a date and time for an evidentiary quality image creation, image accretion, image maintenance, image recording and image logging process (919).

An operator time stamps and updates the Client Project Folio with the date and time when a Child Image was copied to the Detected Images Docu-Vault (7019) (921).

Process to Identify a Plenary image for a Target Object Waif Artifact. A front-end loader might consist of two parts, a bucket in the front and a cab behind the bucket. An image of a front-end loader with both a bucket and a cab would be an image in its entirety. A target object Waif Artifact image is a portion of a larger Plenary image in its entirety. For example, an image of the bucket of a front-end loader is an object artifact waif image of a frontend loader image in its entirety. A target object image, in its entirety, is hereinafter called ‘Plenary image’ but not limited to being called ‘Plenary image’. A Target Object Waif Artifact image is hereinafter called an ‘waif artifact’.

A process to determine a Plenary image for a Target Object Waif Artifact; and to determine a correct Plenary image; and to determine the missing part of a Plenary image, and to transform a Waif artifact into a Plenary image.

A process to determine an object artifact image. An operator initiates a plurality, but not limited to a plurality of, processes to determine the identity of a waif artifact; and to determine a correct Plenary image to which a waif artifact belongs; and to determine the missing part or parts of a Plenary image. A Target Object Waif Artifact may appear to be associated with more than one Plenary image.

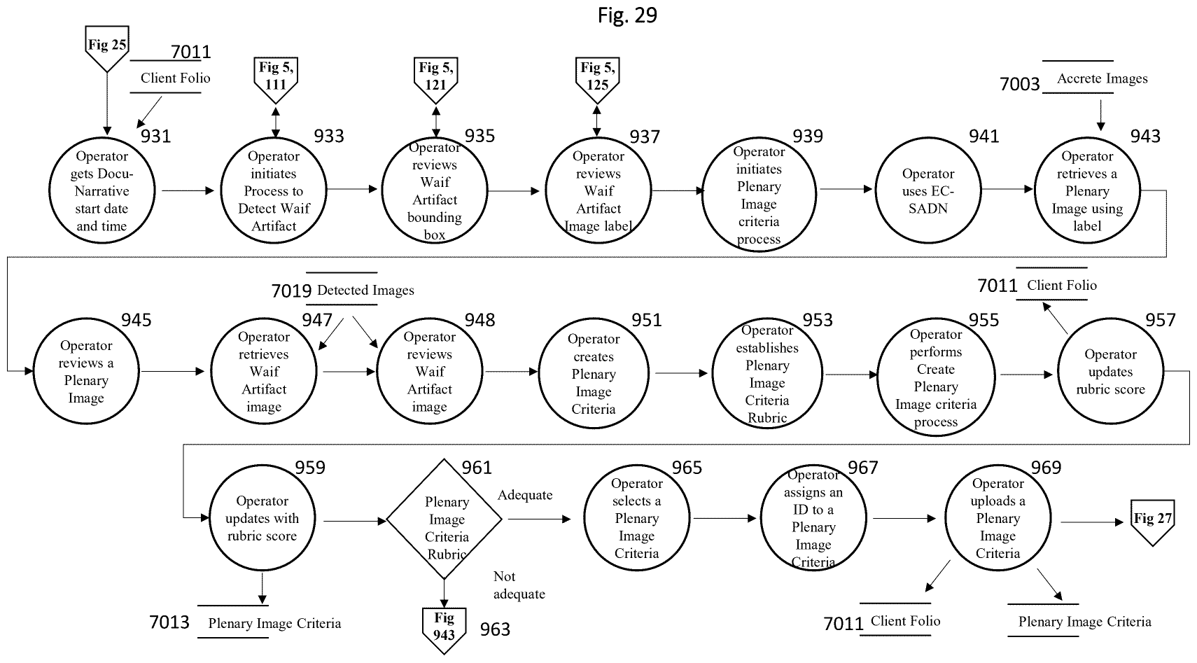

FIG. 29 Method to Create Criteria to Transform a Target Object Waif Artifact Image into a Plenary Image.

An operator retrieves the Docu-Narrative start date and time and the Docu-Narrative end date and time from the Client Project Folio (931).

An operator initiates but is not limited to initiating a Process to Detect a Target Object Waif Artifact at FIG. 5, 115 to identify a Target Object Waif Artifact (933).

An operator reviews the bounding box for a Waif artifact at FIG. 5, 121 (935).

An operator reviews the label for a Waif artifact in FIG. 5, 125 (937).

An operator initiates a process to create criteria for selecting a Plenary image for a Waif Artifact from, but not limited from including images from, Accrete Images Docu-Vault 7003, EarthCam proprietary Curated Images Docu-Vault (7017), Ground Truth Docu-Vault, and from third party accrete image datastores. Accrete Images Docu-Vault 7003, Ground Truth Docu-Vault, EarthCam proprietary Curated Images Docu-Vault (7017) and from third party accrete image datastores, but not limited to Accrete Images Docu-Vault 7003, Ground Truth Docu-Vault, EarthCam proprietary Curated Images Docu-Vault (7017) and from third party accrete image datastores, are hereinafter called ‘Accrete Images Docu-Vault’. An operator uses a label, but not limited to a label, to access a Plenary image from an Accrete Images Docu-Vault 7003. The criteria for selecting a Plenary image for a Waif Artifact includes, but is not limited to including, an Accrete Image label, size, orientation, color, or resolution. (939).

An operator uses an EarthCam proprietary EarthCam-Software Algorithms for a Docu-Narrative Instruction set to determine the criteria for selecting a Plenary image for a Waif Artifact, hereinafter called ‘Plenary image’. The criteria includes, but are not limited to including, selecting a Plenary image for a Waif Artifact (941).

An operator retrieves a Plenary image from an Accrete Images Docu-Vault (7003) (943).

An operator reviews a Plenary image from an Accrete Images Docu-Vault (7003) (945).

An operator retrieves an image or Target Object Waif Artifact from a Detected Images Docu-Vault (7019) (947).

An operator reviews an image or Target Object Waif Artifact accrete image from a Detected Images Docu-Vault (7019) (948).

An operator creates a Plenary image Criteria (951).

An operator establishes a Plenary image for a Target Object Waif Artifact, hereinafter called ‘Plenary image’, Criteria Rubric (961), rules, and algorithm for creating criteria for determining if a Plenary image for a Waif artifact is acceptable or not acceptable (953).

The rubric may be metric, digital, subjective or any combination. The rubric, rules, and algorithm provide the operator with a method for grading the outcome to determine if criteria to determine if a Plenary image, is acceptable or not acceptable and determining if the Plenary image Criteria Rubric score is acceptable.

An operator uses a value of 10 but not limited to 10, to indicate a score which is acceptable. An operator uses a value of 1 but not limited to 1, to indicate a score which is not adequate.

An operator performs the process for determining if criteria for determining if a Plenary image is acceptable or not acceptable (955).

An operator updates the Client Project Folio (7011) with a grade for the outcome of creating criteria for a Plenary image (957).

An operator updates Plenary image Criteria Rubric score in Plenary image Criteria Docu-Vault (7013) with a grade for the outcome of creating criteria for a Plenary image is acceptable or not acceptable process (959.)

An operator uses a Plenary image Criteria Rubric (961).

If a Plenary image Criteria Rubric score is not adequate an operator creates new criteria (963).

If a Plenary image Criteria Rubric score is adequate an operator selects the Plenary image Criteria (965).

An operator assigns a unique identification number to a selected Plenary image criteria (967).

The unique Identification Number incorporates a numeric chronological feature, and a multi-level and hierarchical sequence numbering feature.

An operator uploads Plenary image criteria to a Plenary image Criteria Docu-Vault (7013) (969).

An operator time stamps and updates the Client Project Folio with the date and time when a Plenary image Criteria was uploaded to the Plenary image Criteria Docu-Vault (7013) and an operator uploads the Plenary image criteria to a Plenary image Criteria Docu-Vault (7013) (969).

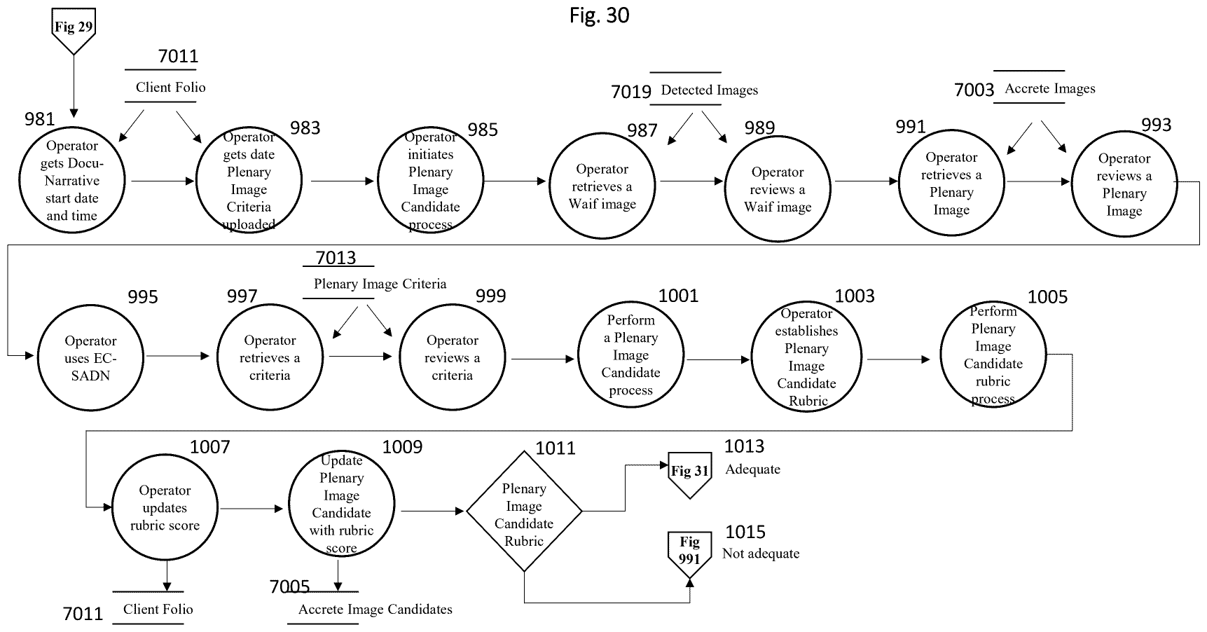

### FIG. 30 Method to Identify Plenary Image Candidates for a Target Object Waif Artifact Image

An operator retrieves the Docu-Narrative start date and time and the Docu-Narrative end date and time from the Client Project Folio (981).

An operator retrieves Client Project Folio with the date and time when the Plenary image Candidate Criteria and Rubric were uploaded to the Plenary image Criteria Docu-Vault (7013) (983)

An operator initiates a Plenary image Candidate image process (985).

An operator retrieves a Target Object Waif Artifact, but not limited to a Waif Artifact image, from a Detected Images Docu-Vault (7019) (987).

An operator reviews a Target Object Waif Artifact, but not limited to a Target Object Waif Artifact, from a Detected Images Docu-Vault (7019) (989).

An operator retrieves a Plenary image Candidate from an Accrete Images Docu-Vault (7003) (991).

An operator reviews a Plenary image Candidate from an Accrete Images Docu-Vault (7003) (993).

An operator uses an EC-SADN Instruction Set and procedure to Select Plenary image Candidates for a Target Object Waif Artifact (995).

An operator retrieves a Plenary image Candidate Criteria from a Plenary image Candidate Criteria Docu-Vault (997).

An operator reviews a Plenary image Candidate Criteria from a Plenary image Candidate Criteria Docu-Vault (999).

An operator uses an EarthCam proprietary EC-SADN Instruction Set to perform a process for identifying a Plenary image Candidate for a Target Object Waif Artifact (1001).

An operator establishes a Plenary image Candidate Rubric, (1011) rules, and algorithm for determining if a Plenary image Candidate for a Waif Image is acceptable (1003).

The rubric may be metric, digital, subjective or any combination. The rubric, rules, and algorithm provide the operator with a method for grading the outcome for determining if a Plenary image Candidate for a Waif Image is acceptable or not acceptable and determining if the Plenary image Candidate Rubric score is acceptable.

An operator uses a value of 10 but not limited to 10, to indicate a score which is acceptable. An operator uses a value of 1 but not limited to 1, to indicate a score which is not adequate.

An operator performs the process for determining if a Plenary image Candidate for a Waif Image is acceptable or not acceptable (1005).

An operator updates the Client Project Folio (7011) with a grade for the outcome of determining if a Plenary image Candidate for a Waif Image is acceptable (1007).

An operator updates a Plenary image Candidate Rubric score in Accrete Images Docu-Vault (7003) with a grade for determining if a Plenary image Candidate for a Waif Image is acceptable (1009).

An operator uses a Plenary image Candidate Rubric (1011).

If the Plenary image Candidate Rubric score is not adequate an operator acquires another image. (1015).

If the Plenary image Candidate Rubric score is adequate, an operator initiates a process to identify a Target Object Waif Artifact within a Complete Candidate Image (1013).

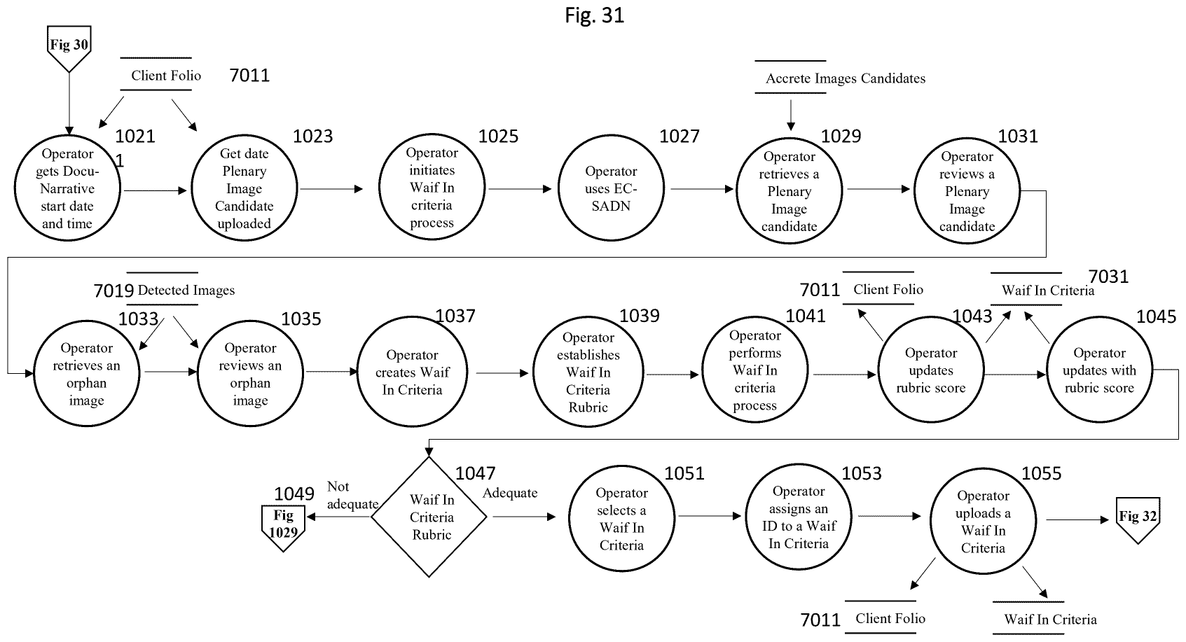

FIG. 31 Method to Create Criteria to Identify a Target Object Waif Image within a Compete Image Candidate

An operator retrieves the Docu-Narrative start date and time and the Docu-Narrative end date and time from the Client Project Folio (1021).

An operator retrieves Client Project Folio with the date and time when an operator uploads a Plenary image Candidate to an Accrete Image Candidates Docu-Vault (7005) (1023).

An operator initiates a process to create criteria for selecting a Target Object Waif Artifact within a Plenary image Candidate in a Plenary images Candidate Docu-Store. The criteria for selecting a Plenary image for a Waif Artifact includes, but is not limited to including, an Accrete Image label, size, orientation, color, or resolution for a Target Object Waif Artifact and a Plenary image Candidate (1025).

An operator uses an EarthCam proprietary EarthCam-Software Algorithms for a Docu-Narrative Instruction set to determine the criteria for identifying a Target Object Waif Artifact within a Plenary image Candidate. The Waif Artifact image within a Plenary image criteria includes, but are not limited to including, an Accrete Image label, size, orientation, color, or resolution for a Plenary image Candidate and a bounding box, size, orientation, color, or resolution for a Target Object Waif Artifact with a Plenary image Candidate (1027).

An operator retrieves a Plenary image Candidate from an Accrete Images Candidate Docu-Vault. (1029).

An operator reviews a Plenary image Candidate from an Accrete Images Candidate Docu-Vault. (1031).

An operator retrieves a Target Object Waif Artifact from a Detected Images Docu-Vault (7019). (1033).

An operator reviews a Target Object Waif Artifact from a Detected Images Docu-Vault (7019). (1035).

An operator creates a Target Object Waif Artifact Within a Plenary image Candidate Criteria, hereinafter called ‘Waif In Criteria’ (1037).

An operator establishes a Waif In Criteria Rubric (104), rules, and algorithm for identifying a Target Object Waif Artifact within a Plenary image Candidate (1039).

The rubric may be metric, digital, subjective or any combination. The rubric, rules, and algorithm provide the operator with a method for grading the outcome for identifying a Target Object Waif Artifact within a Plenary image Candidate is acceptable or not acceptable process and determining if the Waif in Criteria Rubric score is acceptable.

An operator uses a value of 10 but not limited to 10, to indicate a score which is acceptable. An operator uses a value of 1 but not limited to 1, to indicate a score which is not adequate.

An operator performs the process for identifying if a Target Object Waif Artifact within a Plenary image Candidate is acceptable or not acceptable (1041).

An operator updates the Client Project Folio (7011) with a grade for the outcome for identifying a Target Object Waif Artifact within a Plenary image Candidate. (1043).

An operator updates Waif In Criteria Rubric score in Waif In Criteria Docu-Vault with a grade for the outcome of identifying a Target Object Waif Artifact within a Plenary image Candidate is acceptable or not acceptable process. (1045).

An operator uses Waif in Criteria Rubric. (1047).

If the Waif in Criteria Rubric score is not adequate an operator selects another Plenary image Candidate (1049).

If a Waif in Criteria Rubric score is adequate an operator selects the Waif In Criteria (1051).

An operator assigns a unique identification number to a selected Waif In Criteria (1053).

The unique Identification Number incorporates a numeric chronological feature, and a multi-level and hierarchical sequence numbering feature.

An operator uploads a Waif In Criteria to a Saturation Criteria Docu-Vault (7035) and an operator time stamps, and updates the Client Project Folio with the date and time when a Waif In Criteria was uploaded to the Waif In Criteria Docu-Vault (7031) and an operator uploads the Waif In Criteria to a Waif In Criteria Docu-Vault (7031) (1055).

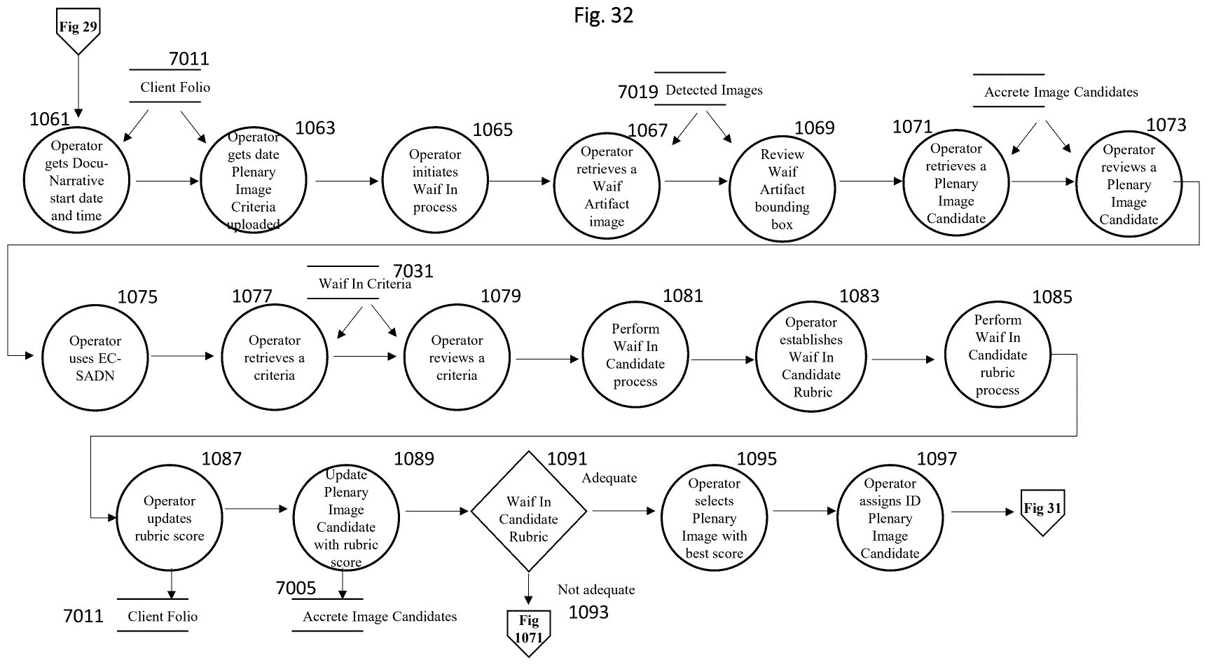

FIG. 32 Method to Identify a Target Object Waif Artifact within a Compete Image

An operator retrieves the Docu-Narrative start date and time and the Docu-Narrative end date and time from the Client Project Folio (1061).

An operator retrieves Client Project Folio with the date and time when the Waif In Criteria and Rubric were uploaded to the Waif In Criteria Docu-Vault (7031) (1063).

An operator initiates a process to identify a Target Object Waif Artifact within a Plenary image Candidate, hereinafter called an ‘Waif In Image’ process (1065).

An operator retrieves a Target Object Waif Artifact from a Detected Images Docu-Vault (7019) (1067).

An operator reviews a Target Object Waif Artifact, and its bounding box, but not limited to a Target Object Waif Artifact and its bounding box, from a Detected Images Docu-Vault (7019) (1069).

An operator retrieves a Plenary image Candidate from an Accrete Image Candidate Docu-Vault (1071).

An operator reviews a Plenary image Candidate from an Accrete Image Candidates Docu-Vault (7005) (1073).

An operator uses an EC-SADN Instruction Set and procedure to Select Plenary image Candidates for a Target Object Waif Artifact (1075).

An operator retrieves a Plenary image Candidate Criteria from a Plenary image Candidate Criteria Docu-Vault (1077).

An operator reviews a Plenary image Candidate Criteria from a Plenary image Candidate Criteria Docu-Vault (1079).

An operator uses an EarthCam proprietary EC-SADN Instruction Set to perform a process for identifying a Plenary image Candidate which has the best rubric score for a Target Object Waif Artifact within a Plenary image Candidate, hereinafter called ‘Waif in Candidate’ process (1081).

### Plenary Image Candidate Rubric

An operator establishes a Plenary image Candidate Rubric, (1091) rules, and algorithm for determining if a Waif Artifact within a Plenary image Candidate accurately resembles a Plenary image and is acceptable. (1083).

The rubric may be metric, digital, subjective or any combination. The rubric, rules, and algorithm provide the operator with a method for grading the outcome for determining if a Waif Artifact within a Plenary image Candidate accurately resembles a Plenary image is acceptable or not acceptable and determining if a Waif in Candidate Rubric score is acceptable.

An operator uses a value of 10 but not limited to 10, to indicate a score which is acceptable. An operator uses a value of 1 but not limited to 1, to indicate a score which is not adequate.

An operator performs the process for determining if a Waif Artifact within a Plenary image Candidate accurately resembles a Plenary image and is acceptable or not acceptable. The process considers, but are not limited to considering, a Plenary image Candidate image label, size, orientation, color, or resolution and a bounding box, size, orientation, color, or resolution for a Target Object Waif Artifact with a Plenary image Candidate. (1085).

An operator updates the Client Project Folio (7011) with a grade for the outcome of for determining if a Waif Artifact within a Plenary image Candidate accurately resembles a Plenary image is acceptable. (1087).

An operator updates a Waif in Candidate Rubric score in Waif In Criteria Docu-Vault (7005) with a grade for determining if a Waif Artifact within a Plenary image Candidate accurately resembles a Plenary image is acceptable. (1089).

An operator uses a Waif in Candidate Rubric. (1091).

If a Waif in Candidate Rubric score is not adequate an operator acquires another Plenary image Candidate image. (1093).

If a Waif in Candidate Rubric score is adequate, an operator initiates a process to identify a Target Object Waif Artifact within a Complete Candidate Image as acceptable. An operator selects a Plenary image Candidate with the best score. (1095).

An operator assigns a unique identification number to a Plenary image Candidate with the best score. The unique Identification Number incorporates a numeric chronological feature, and a multi-level and hierarchical sequence numbering feature. The unique identification number relates the Plenary image Candidate with a Target Object Waif Artifact. (1097).

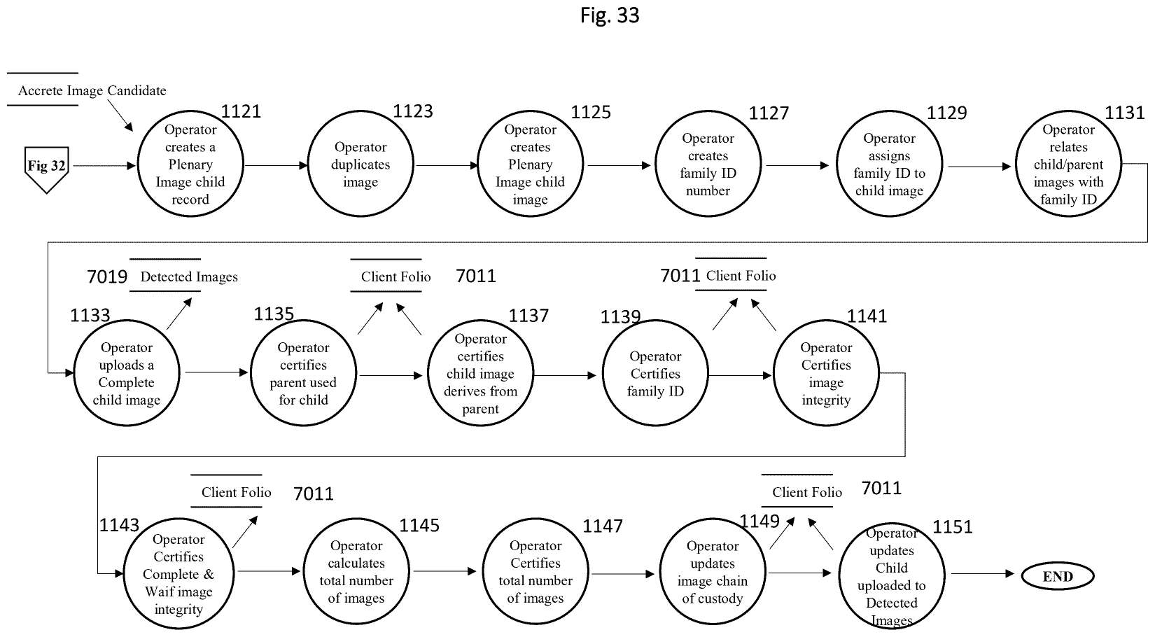

FIG. 33 Method to Create a Complete Child Image from a Parent Target Object Waif Artifact Image

If the Waif in Candidate score is adequate, an Operator uses an EarthCam proprietary EC-SADN Instruction Set to create a child image record from the parent image record, Plenary image Candidate (1121).

The child record is a duplicate of the parent record (1123).

An operator creates a child Plenary image Candidate image with a unique identification number (1125). A unique Identification Number incorporates a numeric chronological feature, and a multi-level and hierarchical sequence numbering feature.

An operator creates a unique family identification number (1127). A unique Family Identification Number incorporates a numeric chronological feature, and a multi-level and hierarchical sequence numbering feature. The child record (Plenary image Candidate) is related to the parent record (Waif Artifact image) by use of a family identification number associated with the Client Identification Number and, Client Location Identification Number and the Docu-narrative start date and time and the Docu-Narrative end date and time.

An operator assigns a unique family identification number to a child image (1129).

An operator relates a child image to a parent image with a unique family identification number (1131).

An operator uploads a child record to a Detected Image Docu-Vault (1133).

An operator certifies and updates the Client Project Folio (7011) with a two-level certification identifying a parent image and an accrete image applied to a child image (1135).

An operator certifies and updates the Client Project Folio (7011) with a two-level certification identifying the child images created for each parent image is derived from a parent image (1137).

An operator certifies and updates the Client Project Folio (7011) with a two-level certification identifying the child images created for each parent image is derived from family identification number used (1139).

An operator uses an EarthCam proprietary EC-SADN Instruction Set and an EarthCam proprietary procedure to ensure images from the start date and time of the Docu-Narrative to the end date and time of the Docu-Narrative have not been altered, concealed, falsified, or destroyed (1141).

An operator authenticates and certifies and updates the Client Project Folio (7011) with a Plenary image Candidate image and a Target Object Waif Artifact have not been altered, concealed, falsified, or destroyed by providing a two-level certification (1143).

An operator uses an EarthCam proprietary EC-SADN Instruction Set and an EarthCam proprietary procedure to calculate the total number of images with an image creation date between the start date and time of the Docu-Narrative and the end date and time of the Docu-Narrative (1145).

An operator certifies and updates the Client Project Folio (7011) with the total number of images with an image creation date between the start date and time of the Docu-Narrative and the end date and time of the Docu-Narrative (1147).

An operator time stamps and updates the Client Project Folio (7011) with a two-level certification and authentication for an image chain of custody including, but is not limited to including, an image identification number, Docu-Vault storage identification, and a date and time for an evidentiary quality image creation, image accretion, image maintenance, image recording and image logging process (1149)

An operator time stamps and updates the Client Project Folio with the date and time when a Child Image was copied to the Detected Images Docu-Vault (7019) (1151).

1. A method for augmenting a target object orphan artifact image within a composite image for producing a target object complete image within the composite image, the method comprising:
Identifying a target object image in the composite image;
determining that only a target object orphan artifact image appears in the composite image;
analyzing the target object orphan artifact image to determine whether a target object complete image can be created;
identifying one or both of a plurality of ground truth images and a plurality of curated images of the target object;
incorporating one or more image elements from the ground truth image of the target object or from the curated image of the target object into the target object orphan artifact image to create a target object child image;
comparing the target object child image with the ground truth image or with the curated image to determine if the target object child image is adequate;
determining a first rubric score responsive to a step of comparing;
if, based on the first rubric score, the target object child image is considered adequate, the target object child image is considered the target object complete image; and
if, based on the first rubric score, the target object child image is not considered adequate then return to a step of incorporating one or more image elements.

2. The method of claim 1, wherein a step of analyzing comprises developing criteria for determining whether the target object complete image can be created from the target object orphan artifact image, developing a second rubric based on the criteria, applying the second rubric to generate a second rubric score, and wherein the second rubric score indicates whether the target object complete image can be created from the target object orphan artifact image.

3. The method of claim 2, wherein the criteria and the second rubric are based on one or more of: image quality, image resolution, environment of the image, camera status and settings, number of pixels per inch in the image, number of pixels in X-direction, number of pixels in Y-direction, camera manufacturer, camera model, camera orientation, camera firmware, YCbCr positioning, image compression, X-direction resolution, Y-direction resolution, exposure time, f-stop, exposure duration, exif version, date and time image was taken, date and time image was digitized, exposure bias, maximum aperture value, metering mode, lighting conditions, color space.

4. The method of claim 1, further comprising segregating target object orphan artifact images into subsets and categorizing the subsets according to augmentation required to generate the target object complete image.

5. The method of claim 1, further comprising maintaining a chain of custody between a target object orphan artifact image and a target object child image derived from the target object orphan artifact image and maintaining a chain of custody between the target object child image and a target object complete image derived from the target object child image.

6. The method of claim 5, wherein maintaining a chain of custody comprises assigning an identifier to the target object complete image, the identifier associated with a progeny of the target object complete image, wherein the identifier comprises one or more of a unique identification number, a family identification number, a numeric chronological indicator, and a multi-level hierarchical numbering scheme.

7. (canceled)

8. The method of claim 6, wherein the identifier is stored in a Docu-Vault.

9. The method of claim 1, further comprising maintaining a chain of custody among a target object complete image, one or more target object child images from which the target object complete image was derived, and a target object orphan artifact image from which the target object complete image was derived.

10. The method of claim 9, wherein the chain of custody comprises a recorded two-level certification.

11. The method of claim 1, further comprising providing a recorded two-level certification that the target object complete image has not been altered, concealed, falsified, or destroyed since the target object complete image was created.

12. The method of claim 1, further comprising maintaining a chain of custody for a target object orphan artifact image and the target object child images that were used to create a target object image complete from the target object orphan artifact image.

13. (canceled)

14. The method of claim 1, wherein a step of analyzing comprises using a boundary box technique to determine whether a target object complete image can be created.

15. The method of claim 1, wherein the composite images are elements of a Docu-Narrative, the Docu-Narrative further including target object images, target object orphan artifact images, and child images, images in the Docu-Narrative related to composite images of a specific site, or composite images requested by a specific client, or all composite images taken between a start date and an end date.

16. (canceled)

17. The method of claim 1, wherein the composite image is an image of a worksite, facility, or property.

18. The method of claim 1, wherein a client identifies target objects to appear in a composite image and criteria and rubric scores for use in augmenting images.

19. The method of claim 1, wherein a target object orphan artifact image appears in a composite image due to mud or raindrops on a lens of a camera that acquired the composite image or due to an environmental condition that obscures a region of the target object.

20. The method of claim 1, wherein ground truth images and curated images are generated using a predetermined resolution and focus.

21. The method of claim 1, further comprising certifying that all images in a Docu Narrative between a start date and an end date have not been altered, concealed, falsified, or destroyed.

22. The method of claim 1, further comprising providing a two-level certification and authentication for a target object complete image, including an image identifier, a Docu-Vault storage identifier, a date and time the target object image complete was created, augmentations of an target object orphan artifact image to produce the target object complete image, maintenance actions regarding the target object complete image, recording of the target object complete image, and logging of the target object complete image, wherein the two-level certification and authentication provide a chain of custody for an image.

23. (canceled)

24. (canceled)

25. The method of claim 1, wherein a step of analyzing employs a deep learning/machine learning application to identify a best match of the target object orphan artifact image to a ground truth image or to a curated image.

26. (canceled)

27. A method for improving an image characteristic of a target object image, wherein the image characteristic relates to one or more of image size, image noise content, image contrast, image blur, and image color saturation, the method comprising:
determining a first rubric score for a target object image, wherein the first rubric score is responsive to a selected image characteristic of the target object image, and wherein the selected image characteristic is related to on one or more of image size, image noise content, image contrast, image blur, and image color saturation within the target object image;
if the first rubric score is not acceptable based on a predetermined first rubric score, identifying a ground truth image or a curated image of the target object;
determining a second rubric score for the ground truth image or the curated image of the target object, wherein the second rubric score is responsive to one or more of image size, image noise content, image contrast, image blur, and image color saturation within the ground truth image or the curated image of the target object;
if the second rubric score is acceptable based on a predetermined second rubric score, incorporating one or more image elements from the ground truth image of the target object or from the curated image of the target object into the target object to create a target object child image;
determining a third rubric score for the target object child image, wherein the third rubric score is responsive to a selected image characteristic of the target object child image, and wherein the selected image characteristic is related to on one or more of image size, image noise content, image contrast, image blur, and image color saturation within the target object child image;
if, based on the third rubric score, the target object child image is considered adequate with respect to one or more of image size, image noise content, image contrast, image blur, and image color saturation within the target object child image, the method terminates; and
if, based on the third rubric score, the target object child image is not considered adequate, identifying another ground truth image or another curated image of the target object and return to a step of determining the second rubric score for the another ground truth image or the another curated image.
